(19) United States
(12) Patent Application Publication
(10) Pub. No.: US 2003/0064241 A1
(43) Pub. Date: Apr. 3, 2003

(54) Steel sheet for fuel tank having corrosion resistance

(76) Inventors: Sachiko Suzuki, Chiba (JP); Hiroyuki Ogata, Chiba (JP); Kazuhiko Kamakura, Chiba (JP); Saiji Matsuoka, Chiba (JP); Shigeru Umino, Chiba (JP)

Correspondence Address: YOUNG & THOMPSON, 745 SOUTH 23RD STREET 2ND FLOOR, ARLINGTON, VA, 22202

(21) Appl. No.: 09/980,014

(22) PCT Filed: Mar. 30, 2001
(86) PCT No.: PCT/JP01/02742

(30) Foreign Application Priority Data
Mar. 30, 2000 (JP) 2000-094944
Jun. 1, 2000 (JP) 2000-164431

(51) Int. Cl. B32B 15/04

(52) U.S. Cl. 428/626; 428/469; 428/323

(57) ABSTRACT

The present invention is a highly corrosion-resistant steel sheet for a fuel tank, in which zinc-based plating layers 2a and 2b and chromate layers 3a and 3b are formed in order by lamination on both surfaces of the steel sheet 1 containing C: 0.0007 to 0.0050 mass %, Si: 0.5 mass % or less, Mn: 2.0 mass % or less, P: 0.10 mass % or less, S: 0.015 mass % or less, Al: 0.01 to 0.20 mass %, N: 0.01 mass % or less, Ti: 0.005 to 0.08 mass %, and B: 0.001 to 0.01 mass %, a first composite coating 4 comprising metal powders of Al and Ni and an amine-modified epoxy resin is formed on one chromate layer 3a, and a second composite coating 5 comprising silica, a lubricant, a particle having conductivity, and at least one kind of organic resin having at least one functional group selected from the group consisting of a hydroxyl group, an isocyanate group, a carboxyl group, a glycidyl group, and an amino group is formed on the other chromate layer 3b. This is a highly corrosion-resistant steel sheet for a fuel tank especially having further improved resistance weldability.

### BACKGROUND ART

The present invention relates to a steel sheet for a fuel tank, and more specifically, it relates to a highly corrosion-resistant steel sheet for a fuel tank having superior resistance weldability, in particular, resistance weldability at the external surface, and superior press formability, as well as superior corrosion resistance, in particular, corrosion resistance to alcohol or gasoline blended with alcohol and formic acid.

The steel sheet for a fuel tank is required to have superior performances, for example, corrosion resistance to fuels and an external environment, weldability, and press formability. First, the corrosion resistance to the fuel will be described.

In North America, Central and South America, Europe, etc., there are many countries having a policy to reduce a rate of dependence on petroleum as a measure regarding energy. Therefore, in these countries, introduction ratio of alcohol (methanol, ethanol) itself or so-called gasohol, in which these are blended into gasoline by 5 to 20%, as a new fuel for automobiles, tends to increase year after year.

However, regarding these alcohol-based fuels, (a) water is likely to be contained, (b) separation into layers is likely to occur due to increase in the amount of blended water and decrease in temperature, (c) there is a possibility of generation of organic acids due to degradation by oxidation (for example, in the case where methanol is used, it changes into formic acid, and in the case where ethanol is used, it changes into acetic acid.), and a separated layer primarily composed of alcohol and/or organic acid and water is generated as a lower layer, and (d) a gasoline mixture containing 40% or more of methanol has corrosiveness further stronger than that of a common gasoline fuel, so that, for example, a plating layer of a terne (Pb-Sn alloy) plated steel sheet, which is a dominant material currently used for tanks, is dissolved.

On the contrary, the steel sheet for a fuel tank of an automobile is required that there are no defects in a welded portion formed by seam welding and spot welding, no corrosion occurs at internal and external surfaces of the tank, and furthermore, no suspended corrosion products, which cause clogging of filters in a fuel circulation system, are generated.

As the steel sheet for a fuel tank of an automobile, which have become commercially practical, for example, a Pb-Sn alloy hot dipped steel sheet as described in Japanese Examined Patent Application Publication No. 57-61833, and a steel sheet in which a Zn plated steel sheet has been subjected to a thick chromate treatment as described in Japanese Examined Patent Application Publication No. 53-19981 have been used.

Regarding corrosion resistance of these materials to alcohol or gasoline blended with alcohol (hereafter referred to as “internal corrosion resistance”.), the Pb-Sn alloy has a disadvantage that it is very likely to dissolve into methanol, so that it is difficult to commercially practice with respect to gasoline blended with methanol.

On the other hand, regarding the internal corrosion resistance of the material in which a zinc electroplated steel sheet has been subjected to the thick chromate treatment, there is some degree of rust preventing function due to a sacrificially protecting function of zinc. However, regarding this material, elution velocity of zinc is high in alcohol and gasoline, large amounts of white precipitates, which tend to suspend, are generated, and clogging of filters in a fuel circulation system occurs. Furthermore, this material has a disadvantage that rust is generated on the base steel after the elution of zinc, so that this material is also insufficient as a steel sheet for a fuel tank.

Therefore, development of a highly corrosion-resistant steel sheet for a fuel tank has been performed in order that superior internal corrosion resistance to alcohol alone or gasoline blended with alcohol, especially, highly corrosive gasoline blended with alcohol and formic acid is exhibited, and in addition, the external surface of the tank exhibits superior corrosion resistance to the external environment (hereafter referred to as “external corrosion resistance”.), and superior press formability and superior resistance weldability are exhibited during tank manufacturing process.

For example, a steel sheet having an organic resin coating containing a metal powder as a layer above a metal plating layer primarily composed of a Pb—Sn alloy or Sn is described in Japanese Examined Patent Application Publication No. 2-18981, and a steel sheet having an organic resin coating containing a metal powder as a layer above a zinc-based plating layer is described in Japanese Examined Patent Application Publication No. 2-18982 and Japanese Examined Patent Application Publication No. 3-25349.

In the aforementioned organic resin coatings described in the aforementioned three specifications, a phenoxy resin constitutes 40% to 90% of the organic resin thereof. Therefore, when the steel sheets having these organic resin coatings are used as materials for gasoline tanks, at the external surface sides thereof, metal powders may be detached from the coating during the press work due to the shortage of affinity between the hydroxyl group included in the phenoxy resin and the metal powder. As a consequence, peeling of plating occurs at the external surface side so as to degrade the press formability.

At the internal surface side of the aforementioned gasoline tank, the internal corrosion resistance of the portion suffered damage due to the detachment of the metal powder included in the aforementioned organic resin coating and the peeling of the plating layer is degraded. The plane portion of the tank, which is not suffered damage, has also inferior internal corrosion resistance, because corrosive liquid is likely to stay between the resin and the metal powder in the coating.

Furthermore, in all of the aforementioned three specifications, since the aforementioned organic resin coating is directly applied by coating, as a layer above the plating layer, without interposition of a chromate or a chemical conversion coating, there is a shortage of adhesion between this organic resin coating and the plating layer. As a consequence, the aforementioned organic resin coating peels off during the press work, and the ability of the organic resin coating to shield from an organic acid and a chlorine ion tends to degrade by a large degree, so that it is difficult to practically use these steel sheets as of now.

Regarding every steel sheet proposed in the aforementioned specifications, the organic resin coating of the surface corresponding to the internal and external surfaces of the tank contains a curing agent as an indispensable component. When the degree of cure is high, hot melting is not likely to occur, and removal of the coating in a step of a nugget production during welding is difficult within an appropriate range of current value. Therefore, sometimes, welding must be performed at a high current value. In such a case, wear and tear of electrodes are remarkable, and it is difficult to continuously weld without maintenance of the electrodes, so that the productivity of the production line is reduced by a large degree. In addition, when the degree of cure is low and an unreacted curing agent is contained, because of low cohesive force of that portion and high hydrophilicity of the unreacted curing agent, corrosion factors (acids, chlorine ions, etc.) are likely to permeate so as to reduce the corrosion resistance of the internal and external surfaces of the tank.

A weldable corrosion-resistant epoxy-based coating composition containing metal powders, in which aluminum, stainless steal, and an alloy thereof are blended, together with a metal powder substantially made of nickel is described in Japanese Unexamined Patent Application Publication No. 64-33173. When this composition is used for coating on a gasoline tank material, the affinity among the epoxy resin, the phenoxy resin, and the metal powders is insufficient for reasons similar to those described above. Therefore, the metal powders may detach from the coating during press work. When this coating is applied to the internal and external surfaces of the tank, the corrosion resistance thereof is degraded due to damages to the coatings and damages to the plating associated therewith. Regarding a plane portion of the tank, which is not suffered damage, both of internal and external surfaces of the tank have inferior corrosion resistance, because corrosive ions are likely to permeate into the interface between the resin and the metal powder where affinity is weak.

When the aforementioned plated steel sheet or steel sheet with the organic coating is welded with high current, weld cracks may occur. Since the weld cracks may extend during actual driving, the occurrence thereof must be prevented.

The weld crack does not occur as long as the welding current is within an appropriate range, although it may occur when welding is performed with a high current value exceeding the appropriate range. In the actual manufacture of the tank, welding is performed within an appropriate range, although since a molded product having a complicated shape is welded, a high current density may be locally brought about depending on the manner of contact between the electrode and the steel sheet. Therefore, a material, in which the weld crack does not occur even if welding is performed with a high current value, must be designed.

The inventors researched regarding development of a steel sheet for a fuel tank satisfying all of the resistance weldability, the press formability, and the corrosion resistance at the internal and external surfaces of the tank, and succeeded in developing the steel sheet, which was already applied for a patent and was laid open, as is disclosed in Japanese Unexamined Patent Application Publication No. 10-337805.

The steel sheet for a fuel tank disclosed in Japanese Unexamined Patent Application Publication No. 10-337805 is a steel sheet in which a zinc-based plating layer and a chemical conversion coating (for example, a chromate coating) are formed in order by lamination on both surfaces of the steel sheet, a metal powder-containing organic resin coating containing metal powders of Al and Ni and an amine-modified epoxy resin is formed on the chemical conversion coating formed on one surface side of the aforementioned steel sheet, and a silica-containing organic resin coating containing at least one kind of organic resin having at least one functional group selected from the group consisting of a hydroxyl group, an isocyanate group, a carboxyl group, a glycidil group, and an amino group, silica, and a lubricant is formed on the chemical conversion coating formed on the other surface side.

The inventors further researched regarding the aforementioned steel sheet for a fuel tank, and discovered that the resistance weldability of the aforementioned steel sheet for a fuel tank, in particular, the weldability when the steel sheets are continuously resistance-welded in a state of being overlapped one another so as to make the electrode directly contact with the silica-containing organic resin coating, is further improved by making the silica-containing organic resin coating contain particles having conductivity, and by making the composition of the steel sheet prior to being applied with zinc-based plating appropriate.

It is an object of the present invention to provide a highly corrosion-resistant steel sheet for a fuel tank especially having further improved resistance weldability compared to that of the steel sheet for a fuel tank, as disclosed in Japanese Unexamined Patent Application Publication No. 10-337805, having superior resistance weldability and press formability, and in addition to this, having superior corrosion resistance, in particular, the corrosion resistance to alcohol or gasoline blended with alcohol and formic acid.

On the other hand, a surface treated steel sheet for fuel container, which is a steel sheet containing C: 0.0005 to 0.0040 wt %, N: 0.0005 to 0.0040 wt %, P: 0.005 to 0.020 wt %, and B: 0.0005 to 0.0030 wt % and having a Zn plating layer as a first plating layer and Ni plating layer as a second plating layer, is disclosed in Japanese Unexamined Patent Application Publication No. 2000-104180. This also provides a steel sheet for a fuel tank in which cracks in a weld metal surface layer during resistance welding under a high-current condition is prevented. However, since Ni of the upper layer becomes noble and Zn of the lower layer becomes base, the corrosion resistance may be degraded by a large degree due to acceleration of dissolution of Zn. Since two different plating layers must be formed, the manufacturing process becomes complicated, and furthermore, since P and B must be controlled within a narrow range in order to achieve an effect of preventing cracks, as a result, there is a large disadvantage regarding the manufacturing cost compared to that in the present invention.

On the other hand, the inventors earnestly researched to further improve the resistance weldability in seam welding and spot welding, and succeeded in developing a steel sheet for a fuel tank, in which no weld cracks occur even when resistance welding are performed with a high current value exceeding an appropriate current range, and which has superior continuous weldability, by making the silica-containing organic resin coating contain particles having conductivity, and by making the steel sheet prior to being applied with zinc-based plating positively contain a B component.

### DISCLOSURE OF INVENTION

That is, the present invention is a highly corrosion-resistant steel sheet for a fuel tank, in which a zinc-based plating layer and a chromate layer are formed in order by lamination on both surfaces of a steel sheet containing C: 0.0007 to 0.0050 mass %, Si: 0.5 mass % or less, Mn: 2.0 mass % or less, P: 0.10 mass % or less, S: 0.015 mass % or less, Al: 0.01 to 0.20 mass %, N: 0.01 mass % or less, Ti: 0.005 to 0.08 mass %, and B: 0.001 to 0.01 mass %, a first composite coating comprising metal powders of Al and Ni and an amine-modified epoxy resin is formed on the chromate layer formed on one surface side of the aforementioned steel sheet, and a second composite coating comprising silica, a lubricant, and a particle having conductivity, and at least one kind of organic resin having at least one functional group selected from the group consisting of a hydroxyl group, an isocyanate group, a carboxyl group, a glycidil group, and an amino group is formed on the chromate layer formed on the other surface side.

Regarding the aforementioned highly corrosion-resistant steel sheet for a fuel tank, the P content in the steel sheet is preferably 0.01 to 0.05 mass %.

Regarding any one of the aforementioned highly corrosion-resistant steel sheets for a fuel tank, the particle having conductivity in the second composite coating is at least one kind selected from the group consisting of a metal particle, a metal compound particle, and a graphite particle.

### BRIEF DESCRIPTION OF THE DRAWINGS

FIG. 1 is a schematic sectional configuration diagram of a structure of a steel sheet for a fuel tank according to the present invention. In the drawing, reference numeral 1 denotes steel sheet, reference numerals 2a and 2b denote zinc-based plating layer, reference numerals 3a and 3b denote chromate layer, reference numeral 4 denotes a first composite coating, and reference numeral 5 denotes a second composite coating.

### BEST MODE FOR CARRYING OUT THE INVENTION

Embodiments according to the present invention will be described below in detail.

Regarding a steel sheet for a fuel tank according to the present invention, the composition of the steel sheet to be plated before plating must be specified as described below.

B: 0.001 to 0.01 mass %

B is one of the most important components among the composition of the steel sheet according to the present invention, and especially has a function of effectively preventing weld cracks. In order to prevent the weld cracks, the B content must be 0.001 mass % or more, although when the content exceeds 0.01 mass %, deep drawing property is degraded. Therefore, the B content was specified to be within the range of 0.001 to 0.01 mass %. The reason for the occurrence of the weld cracks is assumed that during welding, Cu, which is a primary component of the electrode, and Zn, which is a component of the plating, form a liquid metal and this penetrates into grain boundaries so as to cause brittle cracks. However, it is believed that as described above, by making the steel sheet positively contain B, B segregates at grain boundaries so as to strengthen the grain boundaries, and as a result, weld cracks can be prevented. The content is more preferably 0.001 to 0.004 mass %.

C: 0.0007 to 0.0050 mass %

Since C is a component which adversely affects the deep drawing property, and is preferably minimized, the upper limit of the C content was specified to be 0.0050 mass %. Even when the C content is made to be less than 0.0007 mass %, further improvement of the deep drawing property cannot be achieved. On the contrary, since higher degree of decarburization treatment must be performed, and accompanying this, increase in cost is brought about. Therefore the lower limit thereof was specified to be 0.0007 mass %.

Si: 0.5 mass % or less, and Mn: 2.0 mass % or less

Since each of Si and Mn has a function of increasing the strength of the steel, it is added in response to desired strength. However, when the addition amounts of Si and Mn exceed 0.5 mass % and 2.0 mass %, respectively, the deep drawing property is degraded. Therefore, the contents of Si and Mn were specified to be 0.5 mass % or less and 2.0 mass % or less, respectively.

P: 0.1 mass % or less, more preferably 0.01 to 0.05 mass %

P is one of the most important components among the composition of the steel sheet according to the present invention as well as B. In particular, since the grain boundaries are strengthened due to segregation of P, and a function of preventing weld cracks and a function of strengthen the steel are exhibited, P is added in response to desired strength. However, when the P content exceeds 0.10 mass %, the deep drawing property is degraded. Therefore, the P content was specified to be 0.1 mass % or less. In particular, in the case where the weld cracks must be further prevented, the P content is preferably specified to be within the range of 0.01 to 0.05 mass %. This is because when the P content is 0.01 mass % or more, the effect of preventing weld cracks becomes remarkable, and when the P content is 0.05 mass % or less, the deep drawing property tends to be improved.

S: 0.015 mass % or less

Since S is a component which adversely affects the deep drawing property, and is preferably minimized, the upper limit of the S content was specified to be 0.015 mass %.

Al: 0.01 to 0.20 mass %

Al is added in order to decarburize and improve yields of elements for forming carbonitrides. However, when the Al content is less than 0.01 mass %, an effect of the addition is low, on the other hand, even when the content exceeds 0.20 mass %, an effect matching the content cannot be achieved. Therefore, the Al content was specified to be within the range of 0.01 to 0.20 mass %.

N: 0.01 mass % or less

Since N is a component which adversely affects the deep drawing property, and is preferably minimized, the upper limit of the content thereof was specified to be 0.01 mass %.

Ti: 0.005 to 0.08 mass %

Ti bonds with C in the steel so as to precipitate as carbides, and as a consequence, has an effect of preventing degradation of the deep drawing property due to solid solution C. When the Ti content is less than 0.005 mass %, the aforementioned effect is low, although when the content exceeds 0.08 mass %, an effect matching the content cannot be achieved. Therefore, the Ti content was specified to be within the range of 0.005 to 0.08 mass %.

The other composition does not need to be specifically limited, although when crystal particles of hot rolled sheet are made fine so as to improve the deep drawing property after cold rolling-annealing, Nb is preferably made to be contained within the range of 0.0005 to 0.0050 mass %.

In the present invention, incidental impurity components contained in the steel sheet are not particularly specified, as long as the contents of the incidental impurity components are within the ordinary ranges. For example, O as an incidental impurity component is preferably within the range of 0.010 mass % or less.

In the present invention, a zinc-based plating layer and a chromate layer are formed in order by lamination on both surfaces of the steel sheet to be plated which has been adjusted to have the aforementioned composition.

Since the zinc-based plating layer exhibits a base potential compared to that of the iron base material (steel sheet to be plated), even at the press-worked portion in which this plating layer is damaged, occurrence of rust is prevented by action of the sacrificial protection of zinc, so that, in particular, the external corrosion resistance of the fuel tank is improved.

As the zinc-based plating layer, although not specifically limited, layers formed by, for example, zinc electroplating, zinc-nickel alloy electroplating, zinc-cobalt alloy electroplating, zinc-iron alloy electroplating, zinc hot dipping, alloyed zinc hot dipping, zinc-aluminum hot dipping, zinc-magnesium hot dipping, zinc-aluminum-magnesium hot dipping, and in addition to these, zinc-based dispersion plating in which silica, alumina, organic resins, etc., are dispersed in the plating layer, and multilayer plating produced by lamination thereof, are mentioned.

The adhesion amount of the zinc-based plating layer on one surface is preferably 10 to 200 g/m². When the aforementioned adhesion amount is 10 g/m² or more, the action of the sacrificial protection of zinc is sufficient, so that the corrosion resistance is improved. Even if the aforementioned adhesion amount exceeds 200 g/m², further improvement of the corrosion resistance cannot be expected, so that it is uneconomical. The aforementioned adhesion amount is more preferably within the range of 15 to 100 g/m².

The chromate layer has a function of improving the corrosion resistance, and in addition to this, it is an intermediate layer necessary for ensuring sufficient adherence between organic resins contained in first and second composite coatings, described below, formed as the layer above the chromate layer and the zinc-based plating layer.

The adhesion amount of the chromate layer on one surface is preferably 5 to 200 mg/m² in terms of metallic chromium. When the aforementioned adhesion amount is 5 mg/m² or more, not only the corrosion resistance is sufficient, but also the adherence between the organic resin in the aforementioned composite coating and the zinc-based plating layer tends to be improved. When it is 200 mg/m² or less, the chromate coating itself becomes very tough. The adhesion amount of the chromate layer is preferably 10 to 100 mg/m².

The formation of the chromate layer can be performed in accordance with common treatment methods, although not specifically limited. For example, it is also possible to form the chromate layer as a trivalent chromium compound coating by performing an immersion chromate treatment, an electrolysis chromate treatment, etc., using a treatment solution containing chromic acid, a chromate, a dichromate, etc., as a primary agent. Furthermore, the chromate layer may be formed as a coating containing a hexavalent chromium compound by performing a coating type chromate treatment in which a coating of a treatment solution prepared by blending colloidal silica, etc., into the aforementioned treatment solution is applied on a plated steel sheet.

The aforementioned treatment solution primarily contains hexavalent chromium, although in the present invention, as a chromate treatment solution, besides the aforementioned treatment solutions, a so-called trivalent chromate treatment solution not containing hexavalent chromium can be used. Since this trivalent chromate treatment solution does not contain hexavalent chromium, it is preferable from the viewpoint of environment. The trivalent chromate is produced by a method in which chromic acid (CrO₃), as a starting material, is converted into Cr³⁺ using a reducing agent.

As the reducing agent, polysaccarides, for example, starch, fructose, and sucrose, organic acids, for example, oxalic acid and formic acid, phenols, or inorganic compounds, for example, hydrogen peroxide, phosphorous acid, and hydrophosphorous acid, can be used. In addition to the aforementioned method, trivalent chromium compounds can be used.

The chromate layer may be formed, if necessary, by way of a step of washing with water, a step of squeezing with rubber roll, etc., and a step of drying, for example, hot air drying, after the plated steel sheet is subjected to the chromate treatment.

Regarding the steel sheet for a fuel tank according to the present invention, the zinc-based plating layer and the chromate layer are formed in order by lamination on both surfaces of the steel sheet, the first composite coating containing the metal powders of Al and Ni and the amine-modified epoxy resin is formed on the chromate layer formed on one surface side of the aforementioned steel sheet, and the second composite coating containing at least one kind of organic resin having at least one functional group selected from the group consisting of a hydroxyl group, an isocyanate group, a carboxyl group, a glycidyl group, and an amino group, silica, a lubricant, and particles having conductivity is formed on the chromate layer formed on the other surface side of the aforementioned steel sheet.

Since the side of the surface of the steel sheet for a fuel tank according to the present invention, on which the first composite coating is formed, has superior weldability, gasoline resistance, etc., it is preferably used as the internal surface side of a fuel tank, for example, a gasoline tank, (that is, the side which contacts with gasoline). Since the side of the surface, on which the second composite coating is formed, has superior lubricity, corrosion resistance of worked portion, etc., it is preferably used as the external surface side of a fuel tank, for example, a gasoline tank, (that is, the side which contacts with the outside).

The first composite coating is a coating which contains a metal powder and an organic resin having superior corrosion resistance and durability to gasoline blended with alcohol, in particular, methanol itself, or formic acid produced by oxidation of methanol, and serves as a barrier layer for preventing direct contact between the lower layers, that is, zinc-based plating layer and the chromate layer, and the alcohol-based fuel.

The first composite coating is made to contain the metal powder for the primary purpose of ensuring the resistance weldability for the following reason. Since the coating made of organic resin generally has a high electrical insulation property, when the film thickness is 1 μm or less, resistance welding is performed with ease. On the other hand, the first composite coating according to the present invention is preferably a coating of 1 μm to 10 μm from the viewpoint of the internal corrosion resistance. Therefore, the metal powder must be added for the primary purpose of ensuring the resistance weldability.

In order to improve the resistance weldability in the present invention, the first composite coating preferably contains no curing agents for the organic resin. That is, when the first composite coating contains no curing agents for the organic resin, the organic resin in the first composite coating is likely to melt due to heat generation during welding, so that it is advantageous in removal of the coating.

As the metal powder contained in the first composite coating, which preferably has properties exhibiting high resistivity and a large amount of heat generation, specifically Ni, Al, Fe, Cu, etc., are mentioned. Among these, Ni is the most valuable metal because of superior corrosion resistance to methanol and high resistivity. Although Al is not always best for welding because the resistivity and the melting point thereof are lower than those of Ni, by making the first composite coating contain Al having a scaly (flaky) shape, as described below, permeation of corrosive ions in an aqueous solution of formic acid, etc., can be prevented. Therefore Al is a valuable metal for improving the internal corrosion resistance.

Consequently, in the present invention, by making the first composite coating contain an appropriate ratio of Al and Ni powders in combination, the conductivity of the coating can be increased so as to improve the resistance weldability, and the permeation of corrosive ions can be prevented so as to improve the internal corrosion resistance as well. Furthermore, in addition to the powders of Al and Ni as indispensable components, metal powders of Fe, Cu, etc., may be contained in the first composite coating.

The aforementioned metal powder may have either powdery shape or scaly (flaky) shape, although the internal corrosion resistance and the resistance weldability slightly vary depending on the shapes as described above.

Preferably, the Ni powder used in the present invention is particulate and has an average particle diameter of 1 to 9 μm. When the average particle diameter is 1 μm or more, current-carrying points are sufficient, and when the average particle diameter is 9 μm or less, the current-carrying points can be effectively ensured, so that the resistance weldability can be improved even if the content is reduced. More preferably, it is 2 to 7 μm.

The Al powder used in the present invention preferably has an average length of major axis of 8 to 18 μm, an average length of minor axis of 1 to 10 μm, and a thickness of 1 to 5 μm. When the average length of major axis and the average length of minor axis are 8 μm or more and 1 μm or more, respectively, since the area of the scale is large, the performance in preventing the permeation of corrosive ions of formic acid, etc., is increased, so that the internal corrosion resistance tends to be improved. Regarding this advantage, similar phenomenon occurs when only the average length of major axis is long or only the average length of minor axis is long. On the other hand, when the average length of major axis and the average length of minor axis are 18 μm or less and 10 μm or less, respectively, since the coating is not likely to become porous, the strength of the coating is sufficient. When the average thickness is 1 μm or more, the life span of the internal corrosion resistance becomes longer. When the average thickness is 5 μm or less, since the rate of the Al powder exposing at the surface of the first composite coating is reduced, the resistance weldability is improved, so that it is preferable. More preferably, the Al powder has the average length of major axis of 10 to 15 μm, the average length of minor axis of 5 to 8 μm, and the average thickness of 2 to 4 μm.

The total blend amount of the metal powders of Ni and Al in the first composite coating is preferably in a ratio of 30 to 110 parts by weight relative to 100 parts by weight of the organic resin. When the aforementioned total blend amount is 30 parts by weight or more, since there are many current-carrying points and the conductivity is excellent, the resistance weldability is improved. When the aforementioned total blend amount is 110 parts by weight or less, since the first composite coating itself is strong, powdering resistance during press work is improved, and the internal corrosion resistance is improved. More preferably, the aforementioned total blend amount is in a ratio of 45 to 100 parts by weight relative to 100 parts by weight of the organic resin.

In the case where the total blend amount of the metal powders of Ni and Al in the first composite coating is within the aforementioned preferable range, by specifying a ratio Ni/Al (mass ratio) to be 80/20 to 30/70, the resistance weldability and the internal corrosion resistance can be improved while a balance therebetween is maintained. When the ratio Ni/Al is 30/70 or more, since the amount of Ni having a high resistivity is sufficient, the resistance weldability is improved. When the ratio Ni/Al is 80/20 or less, since the amount of Al having a function of preventing permeation of the fuel is increased, the internal corrosion resistance is improved. The ratio Ni/Al is preferably 70/30 to 40/60.

The organic resin contained in the first composite coating needs to have superior corrosion resistance and durability to gasoline, alcohol, and formic acid-based fuel, and furthermore, have superior paint film adherence to an original base plate (steel sheet+plating layer+chromate layer) and superior workability during press work. In the present invention, as the organic resin having the aforementioned characteristics, an amine-modified epoxy resin is used, and as a consequence, superior press formability, superior corrosion resistance to alcohol-based fuel, and superior paint film adherence to an original base plate can be ensured.

The amine-modified epoxy resin refers to an epoxy resin in which an oxirane ring of the epoxy resin constituting a primary skeleton is opened by an amine. As the epoxy resin constituting the primary skeleton of the amine-modified epoxy resin, in order to ensure superior press formability, an epoxy resin having a weight average molecular weight of 5,000 to 50,000, preferably 10,000 to 40,000, is preferably used.

As this epoxy resin constituting the primary skeleton of the amine-modified epoxy resin, for example, bisphenol A type epoxy resins, bisphenol F type epoxy resins, alicyclic epoxy resins, hydantoin type epoxy resins, novolac type epoxy resins, and glycidyl ester type epoxy resins, can be mentioned. Among these, the bisphenol A type epoxy resins and the bisphenol F type epoxy resins are more preferable because in the formation of the first composite coating, those have superior stability as paints, and have wide ranges of manufacturing condition under which coatings having superior press formability and internal corrosion resistance can be stably produced. The epoxy resins may be used solely or as epoxy ester resins in which dicarboxylic acids, for example, adipic acid, azelaic acid, sebacic acid, phthalic acid, and dimer acid are reacted, and polyalkylene glycol diglycidyl ethers may be used concurrently.

Regarding the amine-modified epoxy resin, as the amine added to the oxirane ring of the epoxy resin, foe example, primary or secondary amines, such as monoalkanolamines, e.g., ethylethanolamine and ethanolamine, and dialkanolamines, e.g., diethanolamine, dipropanolamine, and dibutanolamine, are mentioned. Among these, diethanolamines are preferable from the viewpoint of having stable conditions for addition and having high adherence to the chemical conversion coating and metal powders.

In this amine-modified epoxy resin, the mole number of the alkanolamine added to 1 equivalent of oxirane ring of the epoxy resin as the primary skeleton is preferably 0.2 to 1.0 mol. When the epoxy equivalent is 500 to 1,000, the mole number of the alkanolamine is, more preferably, 0.2 to 0.6 mol, and when the epoxy equivalent is 1,000 to 5,000, the mole number of the alkanolamine is, more preferably, 0.6 to 1.0 mol. When the mole number of the alkanolamine added to 1 equivalent of oxirane ring of the epoxy resin is 0.2 or more, the degree of amine modification is sufficient. Therefore, the affinity between the metal powder and the amine-modified epoxy resin is improved, the metal powder is not likely to detach from the coating during press work, and peeling of the plating layer is not likely to occur, so that press formability is improved. In addition, for the reasons similar to those described above, corrosive ions are not likely to stay between resin/metal powder in the coating, as a consequence, since sufficient hydrophobicity can be achieved, corrosive ions of formic acid, etc., are not likely to be attracted into the coating, so that the internal corrosion resistance to highly corrosive methanol fuel is improved. Furthermore, it is economical that the mole number of the added alkanolamine is 1.0 mol or less.

As described above, the amine-modified epoxy resin strengthens the interface between the metal powder and the primary skeleton epoxy resin in the first composite coating. Furthermore, as the feature when the amine-modified epoxy resin is used, it has an effect of improving the interface adhesion force between the first composite coating and the chromate layer as well. This effect of strengthening the interface results in improvement of the corrosion resistance of the plane, prevention of peeling of the coating during press work, and improvement of the internal corrosion resistance of the press-worked portion.

In the present invention, the weight average molecular weight of the amine-modified epoxy resin is preferably within the range of 5,000 to 50,000. When the weight average molecular weight is 5,000 or more, since the molecular weight of the primary skeleton epoxy resin is increased, the intermolecular force functions sufficiently, so that the toughness of the coating is improved. When the weight average molecular weight is 50,000 or less, since the amount of the alkanolamine added to the oxirane ring at the terminal of molecule is increased, the affinity between the resin and the metal powder is preferably increased.

The first composite coating may further contain at least one resin other than the amine-modified epoxy resin, for example, a urethane-modified epoxy resin, a urethane resin, an epoxy resin, an acrylic resin, or an olefin resin.

The thickness of the first composite coating is preferably specified to be 1 to 10 μm. When it is 1 μm or more, the internal corrosion resistance, which is required of the internal surface layer, can be preferably achieved sufficiently. Even when the thickness exceeds 10 μm, effects of improving the internal corrosion resistance and the press formability cannot be expected, and only seam weldability is reduced.

If necessary, additives, for example, a lubricant, a coupling agent, a pigment, a thixotropic agent, and a dispersing agent, can be added to the first composite coating.

The formation of the first composite coating can be performed by the method in which a paint containing the aforementioned amine-modified epoxy resin, the metal powders of Al and Ni, and, various additives appropriately added, if necessary, is prepared, and this is applied by coating as the layer above the chromate layer at the internal surface side.

The preparation of the aforementioned paint can be performed by blending metal powders and various additives, which are added if necessary, into an amine-modified epoxy resin, which is produced by adding alkanolamine to an epoxy resin having an epoxy equivalent of 500 to 5,000, and by reacting at ordinary temperature to 100° C. for 4 to 5 hours, using a sand mill, an attriter, etc., in a predetermined blend ratio.

In the present invention, the second composite coating containing at least one kind of organic resin having at least one functional group selected from the group consisting of a hydroxyl group, an isocyanate group, a carboxyl group, a glycidyl group, and an amino group, silica, a lubricant, and particles having conductivity is formed on the chromate layer formed on the other surface side, specifically, on the external surface side of the tank.

The second composite coating is a lubricant resin coating in which silica and conductive particles are compounded. Regarding a base resin used as the organic resin, it is essential only that the resin is at least one kind of organic resin having at least one functional group selected from the group consisting of a hydroxyl group, an isocyanate group, a carboxyl group, a glycidyl group, and an amino group, and specifically, epoxy resins, alkyd resins, acrylic resins, urethane resins, polyvinyl butyral resins, phenol resins, melamine resins, etc., are mentioned.

In order to minimize the contact area between the mold and the steel sheet during press work, it is important to produce a coating having a high hardness. Therefore, a base resin having a high glass transition point (Tg) is effective.

Tg of the base resin of the second composite coating is preferably 0 to 90° C. When Tg is 0° C. or more, since the hardness of the coating is high at the surface temperatures of the mold and the steel sheet, mold/steel sheet contact ratio is reduced, so that the workability is improved. When Tg is 90° C. or less, since the coating is tough, the workability is improved. More preferably, Tg is 60° C. to 80° C.

The silica contained in the second composite coating is blended in order to impart the corrosion resistance at the external surface of the tank. As this silica, for example, colloidal silica, organosilica sol, silica powder, or organic silicate which is converted to silica by dehydration condensation (for example, ethyl silicate, etc., are concurrently used with an acid catalyst), are mentioned.

The average particle diameter of the aforementioned silica is preferably 5 to 70 nm in order to uniformly disperse silica in the second composite coating.

The blend amount of the silica contained in the second composite coating is preferably specified to be silica: 5 to 80 parts by weight relative to the aforementioned organic resin: 100 parts by weight. When it is 5 parts by weight or more, the corrosion resistance is improved, and when it is 80 parts by weight or less, the coating becomes tough, so that press formability becomes excellent. Since silica has inferior pyrolysis property and tends to reduce the resistance weldability, more preferably, it is specified to be 20 to 60 parts by weight.

In the present invention, a silane coupling agent may be used as a reaction accelerator between the base resin and the silica. As the silane coupling agent used therefor, γ-(2-aminoethyl)aminopropyltrimethoxysilane, γ-glycidoxypropyltrimethoxysilane, etc., are mentioned.

There is no problem in appropriately adding common additives, for example, a reaction accelerator, a stabilizer, and a dispersing agent to the base resin within the scope of the present invention. If anything, it is preferable.

As the lubricant contained in the second composite coating, polyolefin waxes, that is, waxes made of polymers of olefin hydrocarbons, for example, polyethylene, polypropylene, and polybutylene, etc., are preferable. These may be used in combination.

Furthermore, a lubricant containing fluorine may be used. In the second composite coating, these lubricants form a lubricating layer between the coating layer and the mold during press work, as a consequence, excellent press formability of the coating can be maintained.

The blend amount of the lubricant contained in the second composite coating is preferably specified to be lubricant: 1 to 40 parts by weight relative to the aforementioned organic resin: 100 parts by weight. When it is 40 parts by weight or less, the coating strength of the formed second composite coating is improved, and the lubricity is improved. When it is 1 part by weight or more, the lubricity tends to be improved. More preferably, it is specified to be 5 to 30 parts by weight.

The average particle diameter of the aforementioned lubricant is preferably 1 to 7 μm. When the average particle diameter is 1 μm or more, the amount of the lubricant extruded from the second composite coating is increased, so that press formability is improved. When it is 7 μm or less, the second composite coating becomes tough, so that powdering resistance and press formability become excellent.

Any lubricant may be used as long as the softening point thereof is within the range of 70° C. to 150° C. At least two lubricants having different softening points may be used in combination, and the press formability thereby becomes more excellent. When the softening point of the lubricant is 70° C. or more, the elastic modulus of the lubricating layer is not reduced by a large degree even under rigorous press conditions associated with heat generation, the lubricity is not degraded, and the press formability tends to be improved. When it is 150° C. is or less, since the lubricating layer does not become excessively tough due to increase in softening of the lubricant, the lubricity is improved, and the press formability tends to become superior.

Furthermore, in the present invention, the second composite coating are made to be further contain conductive particles in order that among superior performances of the steel sheet for a fuel tank disclosed in Japanese Unexamined Patent Application Publication No. 10-337805, the weldability, in particular, in the case where the resistance welding is performed while electrodes contact with the external surface of the tank, specifically, those contact with the second composite coating, is further improved so as to make continuous welding possible.

As the conductive particle contained in the second composite coating, various particles are known, although in the present invention, at least one kind of particles selected from the group consisting of metal particles, metal compound particles, and graphite particles is preferably used.

Although various particles are known as the conductive particle, in the present invention, at least one kind among metal particles, metal compound particles, and graphite particles is better.

As the metal particles, particles of nickel, tin, copper, etc., particles of an alloy represented by stainless steels, for example, SUS304L, SUS316, and SUS430, are preferable, and especially, particles of nickel, tin, and stainless steel are more preferable.

The metal compound particles refer to metal oxide particles having conductivity, and are represented by a tin oxide powder. This metal oxide particle is preferably not only a single composition, but also a composite oxide, a particle in which an inexpensive particle is used as a core, and the surface thereof is doped with a metal oxide having superior conductivity, a particle subjected to a compounding treatment, etc.

Nano Tek Tinoxide (manufactured by C.I. Kasei Company, Limited) as the tin oxide powder, CELAMASE S-8 (manufactured by Taki Chemical Co., Ltd.) as the colloidal dispersion liquid of tin oxide, SN-100P (manufactured by ISHIHARA SANGYO KAISHA, LTD.) as ATO (antimony tin composite oxide) powder, SN-100D (manufactured by ISHIHARA SANGYO KAISHA, LTD.) as colloidal dispersion liquid of ATO, SC-18 (manufactured by Sakai Chemical Industry, Co., Ltd.) as AZO (antimony zinc composite oxide) powder, CELNAX CX-Z300H (manufactured by NISSAN CHEMICAL INDUSTRIES, LTD) as colloidal dispersion liquid of AZO, etc., are mentioned.

As the graphite particle, graphite powder, colloid sols dispersed in organic solvents and water, etc., are mentioned. As commercially available powder type, for example, AUP (manufactured by Kokuen Kogyo K.K.), TGP-05 (manufactured by TOKAI CARBON CO., LTD.), GP-60S, GP-82, GP-78, and GP-63 (manufactured by Hitachi Yakin K.K.), etc., are mentioned. As the colloid sol dispersed in organic solvents and water, Hitasol GA-66, Hitasol AB-1, and Hitasol GA-315 (manufactured by Hitachi Yakin K.K.), and Baneyphite C-9A and Baneyphite BP-4 (manufactured by Nippon Kokuen Kogyo K.K.) are mentioned.

Regarding the particle diameters of these conductive particles, the average particle diameters thereof are preferably specified to be 0.01 μm to 3.0 μm. When it is 3.0 μm or less, the corrosion resistance of the press-worked portion is improved. When it is 0.01 μm or more, since a current-carrying path is likely to be formed in the coating, the resistance weldability, specifically, spot weldability, tends to be improved. More preferably, it is 0.03 to 2.0 μm, and further preferably, it is 0.05 to 1.5 μm.

The blend amount of the conductive particle contained in the second composite coating is preferably the conductive particle: 1 to 30 parts by weight relative to the aforementioned organic resin: 100 parts by weight. When it is 30 parts by weight or less, the toughness of the coating is increased, and powdering of the coating does not occur, and degradation of the corrosion resistance of the press-worked portion does not occur during press. When it is 1 part by weight or more, since an effect based on the addition of the particle is exhibited, the resistance weldability, especially spot weldability, tends to be improved.

The second composite coating may contain other additives as long as the organic resin (base resin) contains silica, a lubricant, and conductive particles in the aforementioned blend amounts.

Therefore, the steel sheet according to the present invention has the aforementioned configuration. Furthermore, there is no problem in that a lubricant is applied by coating in accordance with difficulty levels of press works. If anything, it is effective from the viewpoint of prevention of damage to the coating.

### EXAMPLES

The present invention will be specifically described below using examples, although the present invention is not limited to these examples.

### Examples

A steel base material (slab) having a chemical composition as shown in Table 1 was heated to 1200° C., and was hot rolled at a finishing temperature of 880° C. and a coiling temperature of 600° C. so as to have a sheet thickness of 3.5 mm, and thereafter, was cold rolled with a draft of 77% so as to produce a cold rolled steel strip. Subsequently, recrystallization annealing was performed with a continuous annealing line at 830° C., and then 0.8% of temper rolling was performed so as to produce a steel sheet to be plated having a sheet thickness of 1.0 mm. On both surfaces of the resulting steel sheet to be plated, various zinc-based plating layers as shown in Tables 2 and 3 were applied. Furthermore, as layers above the zinc-based plating layers, chromate layers, kinds and adhesion amounts of which are shown in Tables 2 and 3, were formed with a roll coater. Thereafter, on the chromate layers of the aforementioned steel sheet, a first composite coating and a second composite coating were formed, respectively.

The first composite coating was formed by the following method. 2,000 g (oxirane ring 1 equivalent) of Epicoat 1007 (manufactured by Yuka Shell Epoxy Co., Ltd., epoxy resin: epoxy equivalent=2,000) and 1,000 g of toluene were put in a reactor provided with a reflux condenser, an agitator, a thermometer, and a nitrogen blowing apparatus, and the temperature was raised to 80° C. after nitrogen replacement so as to produce a homogeneous solution. 52.5 g of diethanolamine was dropped for 30 minutes, and subsequently, reaction was performed for 1 hour to cause amine-modification, so that an amine-modified epoxy resin was prepared. The addition amounts (mol) of alkanolamine relative to 1 equivalent of oxirane ring in the epoxy resin are as shown in Tables 4 and 5. Then, metal powders, an organic solvent, and other additives were added and kneaded so as to produce a suspension. Flaky metal powder of Al and particulate metal powder of Ni were used. The amount of the organic solvent was 60 to 85 parts by weight of the total suspension. A predetermined thickness of coating of this resin mixture (suspension) was applied by roll coating, and was baked under the condition in which the temperature of the sheet reaches 100 to 200° C. after 10 to 30 seconds, so as to form the first composite coating.

The second composite coating was formed by the following method. Water-dispersed colloidal silica (SNOWTEX UP, manufactured by NISSAN CHEMICAL INDUSTRIES, LTD.) was blended into Cellosolve solution containing 30% of solids of SUFERFLEX F-3480D (manufactured by Dai-ichi Kogyo Seiyaku Co., Ltd., polyurethane resin emulsion). CHEMIPEARL W-900 (polyethylene wax manufactured by Mitsui Chemicals, Inc.) was added, and furthermore, conductive particles A to F as shown in Table 6 were blended. A predetermined thickness of coating of this resin mixture was applied by roll coating, and was baked under the condition in which the temperature of the sheet reaches 100 to 200° C. after 10 to 30 seconds, so as to form the second composite coating. The configurations thereof are as shown in Table 6 and Table 7.

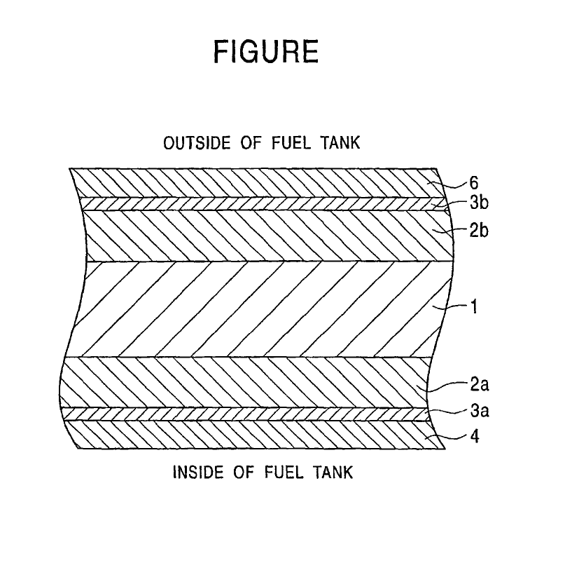

FIG. 1 is a schematic sectional configuration diagram of an example of a steel sheet for a fuel tank according to the present invention produced as described above. The configuration, etc., of each of the resulting steel sheets for a fuel tank (Examples 1 to 136) is as shown in Tables 2 to 7. Evaluations of press formability, resistance weldability, external corrosion resistance, internal corrosion resistance, and brazing property were performed based on evaluation methods as described below. The evaluation results thereof are as shown in Tables 8 and 9. In Comparative Examples 1 to 39, the evaluations were performed regarding the steel sheet according to the invention disclosed in Japanese Unexamined Patent Application Publication No. 10-337805 (Comparative Example 1), terne plated steel sheets (Comparative Examples 9 and 34), aluminum hot dipped steel sheets (Comparative Examples 10 and 35), steel sheets, both surfaces of which were coated with the coatings having compositions as shown in Table 11 (Comparative Examples 11 to 14, and 36 to 39), etc.

### (A) Evaluation Method for Press Formability

Cup drawing test was performed under the following conditions, and the limiting drawing ratio and the powdering resistance were examined so as to evaluate the press formability.

<Press Work Condition>

| | |
|---|---|
| paint oil | 1 g/m² of antirust oil |

Z5 (manufactured by Idemitsu Sekiyu K.K.) was applied

diameter and shape of a punch flat bottom cylinder of 33 mm in diameter

| | |
|---|---|
| clearance | 1 mm |
| blank diameter | variable |
| blank holding force | 2 t |
| drawing speed | 60 mm/sec. |

Cup drawing test was performed under the aforementioned conditions, while the external surface side of the steel sheet was set as the die side, and the internal side was set as the punch side. Then, the limiting drawing ratio (the maximum value of blank diameter of the sample which had been drawn/punch diameter) of each sample was determined so as to evaluate the lubricity based on the following criteria.

∘: 2.1≦limiting drawing ratio

Δ: 2.0≦limiting drawing ratio<2.1

×: limiting drawing ratio<2.0

Furthermore, by examining the degree of powdering of the resin coating on the external side wall of a cup after cup drawing test with a blank diameter of 60 mm, the powdering resistance was evaluated. That is, C count ratio of before and after the working (C spot count after the working/C spot count before the working) was measured by EPMA, and the powdering resistance was evaluated based on the following criteria.

∘: 0.8≦C count ratio

Δ: 0.2 ≦C count ratio<0.8

×: C count ratio<0.2

(B) Evaluation Method for Resistance Weldability

Regarding the resistance weldability, seam weldability and spot weldability were independently evaluated.

<Seam Welding Condition>

| | |
|---|---|
| electrode | chromium-copper alloy, |

a disk-shaped electrode in which the central part has a cross section of 15 mmR and a width of 4.5 mm and the edge portion has 4 mmR and a width of 8 mm (the second composite coating contacts with both of the upper and lower electrodes)

| | |
|---|---|
| welding method | double-layer, lap seam welding |
| electrode force | 400 kgf (3,920 N) |
| welding time | current passage on for 2/50 |

seconds, and current passage off for 1/50 seconds

| | |
|---|---|
| cooling | internal cooling |
| welding speed | 2.5 m/min. |
| welding current | variable |

Under the aforementioned conditions, 300 m of continuous welding was repeated, and further 200 m (total 500 m) of continuous welding was performed using a plurality of test pieces having a size of 500×300 mm while internal surfaces thereof are contacted with each other, and intermediate status of the welding was confirmed at every 10 m using test pieces of 100 mm×200 mm. That is, regarding the welding test pieces of 100 mm×200 mm, continuous seam weldability was evaluated based on the presence or no presence of fracture in the base material (steel sheet to be plated) in T peel tensile test.

∘: fracture in the base material (continuous welding of more than 300 m, but 500 m or less)

Δ: fracture in the nugget (continuous welding of more than 300 m, but 500 m or less), fracture in the base material (continuous welding of 300 m or less)

×: fracture in the nugget (continuous welding of 300 m or less)

In addition, welding was performed with two kinds of current values which are in the range up to the upper limit of the appropriate current range +3 kA and +7 kA, respectively, and the sections of the welded portions were observed. The sample was taken, parallel to the direction of the welding, from the central part of the welded portion, and was embedded in a resin. Subsequently, after polishing, etching and observation with an optical microscope were performed so as to count the occurrence number of weld cracks of the total samples. The evaluation was based on the following evaluation criteria.

∘: No occurrence

Δ: 1 or 2 cracks

×: 3 cracks or more

<Spot Weldability>

electrode; chromium-copper alloy, DR type and CF type

sheet arrangement; double-layer,

DR type (the first composite coating contacts therewith)

CF type (the second composite coating contacts therewith)

welding condition; as shown in Table 10

cooling; internal cooling

current in continuous welding; welding current value, at which surface flash occur, of each material—0.5 kA

Under the conditions as shown in Table 10, continuous welding was performed using a plurality of test pieces having a size of 100×200 mm which were overlapped while the first composite coating contacted with the DR type electrode, and the second composite coating contacted with the CF type electrode, and intermediate status of the welding was confirmed at every 20 welding spots using test pieces of 20 mm×80 mm. That is, the welded portion of the welding test piece of 20 mm×80 mm was peeled off, length of major axis and minor axis of the button were measured, and a welding spot in which the length of the minor axis satisfies 4 times the square root t or more was judged as being acceptable. The evaluation was based on the following evaluation criteria depending on the number of acceptable welding spots.

∘: 600 welding spots or more

Δ: 300 welding spots or more, but less than 600 welding spots

×: less than 300 welding spots

In addition, welding was performed with two kinds of current values which are in the range up to the upper limit of the appropriate current range +3 kA and +7 kA, respectively, and the sections of the welded portion were observed. The sample taken from the central part of the welded portion was embedded in a resin. Subsequently, after polishing, etching and observation with an optical microscope were performed so as to count the occurrence number of weld cracks of the total samples. The evaluation was based on the following evaluation criteria.

∘: No occurrence

Δ: 1 or 2 cracks

×: 3 cracks or more

(C) Evaluation Method for External Corrosion Resistance

The evaluation of the external corrosion resistance of the second composite coating was performed as described below. Under the conditions of JAS0-M610 method (each cycle is composed of spraying salt water for 2 hours→drying at 60° C. and RH of 20% to 30% for 4 hours→at 50° C. and RH of 98% for 2 hours), the flat portion was subjected to 300 cycles of tests, and the flat cross cut portion and the side wall portion of the cup worked under the press work condition (blank diameter 60 mm) of (A) were subjected to 100 cycles of tests. Then, each of decrement of the sheet thickness was measured, and the external corrosion resistance was evaluated based on the following criteria. Although in actual manufacture of the tank, generally, a topcoat is applied by painting as the layer above the coating, in order to evaluate the performance of the second composite coating, in this test, the performance was evaluated without the topcoat.

∘: corrosion depth<0.5 mm

Δ: 0.5 mm≦corrosion depth<1.0 mm

×: 1.0 mm≦corrosion depth (perforated)

(D) Evaluation Method for Internal Corrosion Resistance

The flat portion and the internal surface of the cup worked under the press work condition (blank diameter 60 mm) of (A) were evaluated. When the flat portion was evaluated, a test piece of 20 mm×100 mm was immersed in a fuel of unleaded gasoline/500 ppm formic acid aqueous solution=1/1 (weight) at ordinary temperature for one month so as to measure the rate (%) of the area of rust occurrence. When the internal surface of the cup was evaluated, the aforementioned fuel was put into the cup to about 80% of the volume, and after standing at ordinary temperature for one month, the rate (%) of the area of rust occurrence of the internal surface of the cup was measured. Since the aforementioned fuel separated into the lower layer of the formic acid aqueous solution and the upper layer of the unleaded gasoline in accordance with the order of specific gravity, the rates of the area of rust occurrence of the respective portions were measured, and the internal corrosion resistance was evaluated based on the following criteria.

∘: rate of the area of rust occurrence<50%

Δ: 50%≦rate of the area of rust occurrence<80%

×: 80%≦rate of the area of rust occurrence

(E) Evaluation Method for Brazing Property

Two sheets of samples having a size of 15 mm×200 mm were prepared, and were lapped by 15 mm×15 mm while the second composite coatings thereof are facing each other. Thereafter, a brazing metal (manufactured by Ishifuku Metal Industry Co., Ltd., IS-344, JIS standard name: King solder #101) and a flux (manufactured by Ishifuku Metal Industry Co., Ltd., Ishifuku flux #6) were poured therebetween by gas heating (heating time 10 seconds), so that brazing was performed. Subsequently, shearing tensile test was performed, and the brazing property was evaluated based on the following criteria.

∘: fracture in the base material

Δ: combination of fracture in the base material and peeling between the base material/brazing metal

×: peeling between the base material/brazing metal

As is clear from the evaluation results shown in Table 8 and Table 9, all Examples exhibited superior press formability, resistance weldability, internal and external surface resistivity, and brazing property. In particular, it is clear that regarding Examples 4, 5, and 73 to 134, in which P contents of the aforementioned steel sheet are within the range of 0.01% to 0.05% by mass, the weld crack does not occur, and remarkably superior resistance weldability is exhibited even under rigorous resistance welding conditions.

TABLE 1
Steel composition

| Steel | Chemical composition (mass %) | | | | | | | | | | | |
|---|---|---|---|---|---|---|---|---|---|---|---|---|
| No. | C | Si | Mn | P | S | Al | N | Ti | B | Nb | | |
| A | 0.0025 | 0.01 | 0.12 | 0.008 | 0.0025 | 0.022 | 0.0019 | 0.025 | 0.0015 | — | Claim 1 | Invented |
| B | 0.0025 | 0.01 | 0.12 | 0.008 | 0.0025 | 0.022 | 0.0019 | 0.025 | 0.0018 | — | | steel |
| C | 0.0025 | 0.01 | 0.12 | 0.008 | 0.0025 | 0.022 | 0.0019 | 0.025 | 0.0025 | — | | |
| D | 0.0023 | 0.01 | 0.12 | 0.011 | 0.0007 | 0.025 | 0.0018 | 0.023 | 0.0012 | 0.002 | | |
| E | 0.0023 | 0.01 | 0.12 | 0.011 | 0.0007 | 0.025 | 0.0018 | 0.023 | 0.0038 | — | | |
| F | 0.0025 | 0.01 | 0.12 | 0.005 | 0.0025 | 0.022 | 0.0019 | 0.025 | 0.0024 | — | | |
| G | 0.0025 | 0.01 | 0.12 | 0.060 | 0.0025 | 0.022 | 0.0019 | 0.025 | 0.0024 | — | | |
| H | 0.0025 | 0.01 | 0.12 | 0.026 | 0.0025 | 0.022 | 0.0019 | 0.025 | 0.0015 | — | Claim 2 | |
| I | 0.0025 | 0.01 | 0.12 | 0.026 | 0.0025 | 0.022 | 0.0019 | 0.025 | 0.0018 | — | | |
| J | 0.0025 | 0.01 | 0.12 | 0.026 | 0.0025 | 0.022 | 0.0019 | 0.025 | 0.0025 | — | | |
| K | 0.0023 | 0.01 | 0.12 | 0.030 | 0.0007 | 0.025 | 0.0018 | 0.023 | 0.0012 | 0.002 | | |
| L | 0.0023 | 0.01 | 0.12 | 0.026 | 0.0007 | 0.025 | 0.0018 | 0.023 | 0.0038 | — | | |
| M | 0.0025 | 0.01 | 0.12 | 0.008 | 0.0025 | 0.022 | 0.0019 | 0.025 | — | — | | Comparative |
| N | 0.0025 | 0.01 | 0.12 | 0.008 | 0.0025 | 0.022 | 0.0019 | 0.025 | 0.0157 | — | | steel |
| O | 0.0025 | 0.01 | 0.12 | 0.026 | 0.0025 | 0.022 | 0.0019 | 0.025 | — | — | | |
| P | 0.0025 | 0.01 | 0.12 | 0.026 | 0.0025 | 0.022 | 0.0019 | 0.025 | 0.0157 | — | | |
| Q | 0.0025 | 0.01 | 0.12 | 0.005 | 0.0025 | 0.022 | 0.0019 | 0.025 | — | — | | |

TABLE 2-1

| | | | Plating | | Chromate | |
|---|---|---|---|---|---|---|
| | | | | Adhesion | | Adhesion |
| | | Steel | Kind | amount | Kind | amount |
| Category | No. | No. | *Note 1 | (g/m²) | *Note 2 | (mg/m²) |
| Example | 1 | A | EG | 40 | A | 40 |
| | 2 | B | EG | 40 | A | 40 |
| | 3 | C | EG | 40 | A | 40 |
| | 4 | D | EG | 40 | A | 40 |
| | 5 | E | EG | 40 | A | 40 |
| | 6 | C | EG | 40 | A | 40 |
| | 7 | C | EZN | 40 | A | 40 |
| | 8 | C | GI | 40 | A | 40 |
| | 9 | C | GA | 40 | A | 40 |
| | 10 | C | GF | 40 | A | 40 |
| | 11 | C | GL | 40 | A | 40 |
| | 12 | C | EG | 10 | A | 40 |
| | 13 | C | EG | 100 | A | 40 |
| | 14 | C | EG | 180 | A | 40 |
| | 15 | C | EG | 180 | B | 40 |
| | 16 | C | EG | 180 | A | 15 |
| | 17 | C | EG | 180 | A | 90 |
| | 18 | C | EG | 40 | A | 40 |
| | 19 | C | EG | 40 | A | 40 |
| | 20 | C | EG | 40 | A | 40 |
| | 21 | C | EG | 40 | A | 40 |
| | 22 | C | EG | 40 | A | 40 |
| | 23 | C | EG | 40 | A | 40 |
| | 24 | C | EG | 40 | A | 40 |
| | 25 | C | EG | 40 | A | 40 |
| | 26 | C | EG | 40 | A | 40 |
| | 27 | C | EG | 40 | A | 40 |
| | 28 | C | EG | 40 | A | 40 |
| | 29 | C | EG | 40 | A | 40 |
| | 30 | C | EG | 40 | A | 40 |
| | 31 | C | EG | 40 | A | 40 |
| | 32 | C | EG | 40 | A | 40 |
| | 33 | C | EG | 40 | A | 40 |
| | 34 | C | EG | 40 | A | 40 |
| | 35 | C | EG | 40 | A | 40 |
| | 36 | C | EG | 40 | A | 40 |
| | 37 | C | EG | 40 | A | 40 |
| | 38 | C | EG | 40 | A | 40 |
| | 39 | C | EG | 40 | A | 40 |
| | 40 | C | EG | 40 | A | 40 |
| | 41 | C | EG | 40 | A | 40 |
| | 42 | C | EG | 40 | A | 40 |
| | 43 | C | EG | 40 | A | 40 |
| | 44 | C | EG | 40 | A | 40 |
| | 45 | EG | 40 | A | 40 | |

Note 1
EG: Zinc electroplated steel sheet
EZN: Zinc-nickel alloy electroplated steel sheet (Ni content: 12 mass %)
GI: Zinc hot dipped steel sheet
GA: Alloyed zinc hot dipped steel sheet (Fe content: 10 mass %)
GF: Zinc-5% aluminum hot dipped steel sheet (Al content: 5 mass %)
GL: Zinc-55% aluminum hot dipped steel sheet (Al content: 55 mass %)
Note 2
A: Coating type (roll coating → baking), chromate containing hexavalent chromium
B: Reaction type (permeation → water washing → hot air drying), chromate containing hexavalent chromium
C: Coating type, Cr6⁺: content 10 mass %

TABLE 2-2

| | | | Plating | | Chromate | |
|---|---|---|---|---|---|---|
| | | | | Adhesion | | Adhesion |
| | | Steel | Kind | amount | Kind | amount |
| Category | No. | No. | *Note 1 | (g/m²) | *Note 2 | (mg/m²) |
| | 46 | C | EG | 40 | A | 40 |
| | 47 | C | EG | 40 | A | 40 |
| | 48 | C | EG | 40 | A | 40 |
| | 49 | C | EG | 40 | A | 40 |
| | 50 | C | EG | 40 | A | 40 |
| | 51 | C | EG | 40 | A | 40 |
| | 52 | C | EG | 40 | A | 40 |
| | 53 | C | EG | 40 | A | 40 |
| | 54 | C | EG | 40 | A | 40 |
| | 55 | C | EG | 40 | A | 40 |
| | 56 | C | EG | 40 | A | 40 |
| | 57 | C | EG | 40 | A | 40 |
| | 58 | C | EG | 40 | A | 40 |
| | 59 | C | EG | 40 | A | 40 |
| | 60 | C | EG | 40 | A | 40 |
| | 61 | C | EG | 40 | A | 40 |
| | 62 | C | EG | 40 | A | 40 |
| | 63 | C | EG | 40 | A | 40 |
| | 64 | C | EG | 40 | A | 40 |
| | 65 | C | EG | 40 | A | 40 |
| | 66 | C | EG | 40 | A | 40 |
| | 67 | C | EG | 40 | A | 40 |
| | 68 | C | EG | 40 | A | 40 |
| | 69 | C | EG | 40 | A | 40 |
| | 70 | C | EG | 40 | A | 40 |
| | 71 | C | EG | 40 | A | 40 |
| | 72 | C | EG | 40 | A | 40 |
| | 73 | H | EG | 40 | A | 40 |
| | 74 | I | EG | 40 | A | 40 |
| | 75 | J | EG | 40 | A | 40 |
| | 76 | K | EG | 40 | A | 40 |
| | 77 | L | EG | 40 | A | 40 |
| | 78 | J | EG | 40 | A | 40 |
| | 79 | J | EZN | 40 | A | 40 |
| | 80 | J | GI | 40 | A | 40 |
| | 81 | J | GA | 40 | A | 40 |
| | 82 | J | GF | 40 | A | 40 |
| | 83 | J | GL | 40 | A | 40 |
| | 84 | J | EG | 10 | A | 40 |
| | 85 | J | EG | 100 | A | 40 |
| | 86 | J | EG | 180 | A | 40 |
| | 87 | J | EG | 180 | B | 40 |
| | 88 | J | EG | 180 | A | 15 |
| | 89 | J | EG | 180 | A | 90 |
| | 90 | J | EG | 40 | A | 4 |

Note 1
EG: Zinc electroplated steel sheet
EZN: Zinc-nickel alloy electroplated steel sheet (Ni content: 12 mass %)
GI: Zinc hot dipped steel sheet
GA: Alloyed zinc hot dipped steel sheet (Fe content: 10 mass %)
GF: Zinc-5% aluminum hot dipped steel sheet (Al content: 5 mass %)
GL: Zinc-55% aluminum hot dipped steel sheet (Al content: 55 mass %)
Note 2
A: Coating type (roll coating → baking), chromate containing hexavalent chromium
B: Reaction type (permeation → water washing → hot air drying), chromate containing hexavalent chromium
C: Coating type, Cr6⁺: content 10 mass %

TABLE 3-1

| | | | Plating | | Chromate | |
|---|---|---|---|---|---|---|
| | | | | Adhesion | | Adhesion |
| | | Steel | Kind | amount | Kind | amount |
| Category | No. | No. | *Note 1 | (g/m²) | *Note 2 | (mg/m²) |
| Example | 91 | J | EG | 40 | A | 40 |
| | 92 | J | EG | 40 | A | 40 |
| | 93 | J | EG | 40 | A | 40 |
| | 94 | J | EG | 40 | A | 40 |
| | 95 | J | EG | 40 | A | 40 |
| | 96 | J | EG | 40 | A | 40 |
| | 97 | J | EG | 40 | A | 40 |
| | 98 | J | EG | 40 | A | 40 |
| | 99 | J | EG | 40 | A | 40 |
| | 100 | J | EG | 40 | A | 40 |
| | 101 | J | EG | 40 | A | 40 |
| | 102 | J | EG | 40 | A | 40 |
| | 103 | J | EG | 40 | A | 40 |
| | 104 | J | EG | 40 | A | 40 |
| | 105 | J | EG | 40 | A | 40 |
| | 106 | J | EG | 40 | A | 40 |
| | 107 | J | EG | 40 | A | 40 |
| | 108 | J | EG | 40 | A | 40 |
| | 109 | J | EG | 40 | A. | 40 |
| | 110 | J | EG | 40 | A | 40 |
| | 111 | J | EG | 40 | A | 40 |
| | 112 | J | EG | 40 | A | 40 |
| | 113 | J | EG | 40 | A | 40 |
| | 114 | J | EG | 40 | A | 40 |
| | 115 | J | EG | 40 | A | 40 |
| | 116 | J | EG | 40 | A | 40 |
| | 117 | J | EG | 40 | A | 40 |
| | 118 | J | EG | 40 | A | 40 |
| | 119 | J | EG | 40 | A | 40 |
| | 120 | J | EG | 40 | A | 40 |
| | 121 | J | EG | 40 | A | 40 |
| | 122 | J | EG | 40 | A | 40 |
| | 123 | J | EG | 40 | A | 40 |
| | 124 | J | EG | 40 | A | 40 |
| | 125 | J | EG | 40 | A | 40 |
| | 126 | J | EG | 40 | A | 40 |
| | 127 | J | EG | 40 | A | 40 |
| | 128 | J | EG | 40 | A | 40 |
| | 129 | J | EG | 40 | A | 40 |
| | 130 | J | EG | 40 | A | 40 |
| | 131 | J | EG | 40 | A | 40 |
| | 132 | J | EG | 40 | A | 40 |
| | 133 | J | EG | 40 | A | 40 |

Note 1
EG: Zinc electroplated steel sheet
EZN: Zinc-nickel alloy electroplated steel sheet (Ni content: 12 mass %)
GI: Zinc hot dipped steel sheet
GA: Alloyed zinc hot dipped steel sheet (Fe content: 10 mass %)
GF: Zinc-5% aluminum hot dipped steel sheet (Al content: 5 mass %)
GL: Zinc-55% aluminum hot dipped steel sheet (Al content: 55 mass %)
Note 2
A: Coating type (roll coating → baking), chromate containing hexavalent chromium
B: Reaction type (permeation → water washing → hot air drying), chromate containing hexavalent chromium
C: Coating type, Cr6⁺: content 10 mass %

TABLE 3-2

| | | | Plating | | Chromate | |
|---|---|---|---|---|---|---|
| | | | | Adhesion | | Adhesion |
| | | Steel | Kind | amount | Kind | amount |
| Category | No. | No. | *Note 1 | (g/m²) | *Note 2 | (mg/m²) |
| | 134 | J | EG | 40 | A | 40 |
| | 135 | F | EG | 40 | A | 40 |
| | 136 | G | EG | 40 | A | 40 |
| Comparative | 1 | M | EG | 40 | A | 40 |
| Example | 2 | N | EG | 40 | A | 40 |
| | 3 | C | EG | 40 | — | 0 |
| | 4 | C | EG | 40 | A | 40 |
| | 5 | C | EG | 40 | A | 40 |
| | 6 | C | EG | 40 | A | 40 |
| | 7 | C | EG | 40 | A | 40 |
| | 8 | C | EG | 40 | A | 40 |
| | 9 | C | Tern | 40 | None | None |
| | 10 | C | Al | 40 | None | None |
| | 11 | C | GA | 45 | C | .40 |
| | 12 | C | GA | 45 | C | 40 |
| | 13 | C | GA | 45 | C | 40 |
| | 14 | C | GA | 45 | C | 40 |
| | 15 | 0 | EG | 40 | A | 40 |
| | 16 | P | EG | 40 | A | 40 |
| | 17 | Q | EG | 40 | A | 40 |
| | 18 | J | EG | 40 | 0 | |
| | 19 | J | EG | 40 | A | 40 |
| | 20 | J | EG | 40 | A | 40 |
| | 21 | J | EG | 40 | A | 40 |
| | 22 | J | EG | 40 | A | 40 |
| | 23 | J | EG | 40 | A | 40 |
| | 24 | J | EG | 40 | A | 40 |
| | 25 | J | EG | 40 | A | 40 |
| | 26 | J | EG | 40 | A | 40 |
| | 27 | J | EG | 40 | A | 40 |
| | 28 | J | EG | 40 | A | 40 |
| | 29 | J | EG | 40 | A | 40 |
| | 30 | J | EG | 40 | A | 40 |
| | 31 | J | EG | 40 | A | 40 |
| | 32 | J | EG | 40 | A | 40 |
| | 33 | J | EG | 40 | A | 40 |
| | 34 | J | Tern | 40 | None | None |
| | 35 | J | Al | 40 | None | None |
| | 36 | J | GA | 45 | C | 40 |
| | 37 | J | GA | 45 | C | 40 |
| | 38 | J | GA | 45 | C | 40 |
| | 39 | J | GA | 45 | C | 40 |

Note 1
EG: Zinc electroplated steel sheet
EZN: Zinc-nickel alloy electroplated steel sheet (Ni content: 12 mass %)
GI: Zinc hot dipped steel sheet
GA: Alloyed zinc hot dipped steel sheet (Fe content: 10 mass %)
GF: Zinc-5% aluminum hot dipped steel sheet (Al content: 5 mass %)
GL: Zinc-55% aluminum hot dipped steel sheet (Al content: 55 mass %)
Note 2
A: Coating type (roll coating → baking), chromate containing hexavalent chromium
B: Reaction type (permeation → water washing → hot air drying), chromate containing hexavalent chromium
C: Coating type, Cr6⁺: content 10 mass %

TABLE 4-1

| | | The first composite coating | | | | | | | | | | |
|---|---|---|---|---|---|---|---|---|---|---|---|---|
| | | Coating composition | | | | | | Al powder | | | | |
| | | (parts by weight) | | | Amine-modified | | | Length | | | Ni | |
| | | Amine- | | | epoxy resin | | | of | Length | | powder | |
| | | modified | | | | Alkanolamine | | major | of minor | | Particle | Film |
| | | epoxy | Al | Ni | Weight | Kind | Addition | axis | axis | Thickness | diameter | thickness |
| Category | No. | resin | powder | powder | average | *Note 1 | amount | (μm) | (μm) | (μm) | (μm) | (μm) |
| Exampl | 1 | 100 | 35 | 35 | 35000 | A | 0.5 | 13 | 5 | 2 | 5 | 3 |
| | 2 | 100 | 35 | 35 | 35000 | A | 0.5 | 13 | 5 | 2 | 5 | 3 |
| | 3 | 100 | 35 | 35 | 35000 | A | 0.5 | 13 | 5 | 2 | 5 | 3 |
| | 4 | 100 | 35 | 35 | 35000 | A | 0.5 | 13 | 5 | 2 | 5 | 3 |
| | 5 | 100 | 35 | 35 | 35000 | A | 0.5 | 13 | 5 | 2 | 5 | 3 |
| | 6 | 100 | 35 | 35 | 35000 | A | 0.5 | 13 | 5 | 2 | 5 | 3 |
| | 7 | 100 | 35 | 35 | 35000 | A | 0.5 | 13 | 5 | 2 | 5 | 3 |
| | 8 | 100 | 35 | 35 | 35000 | A | 0.5 | 13 | 5 | 2 | 5 | 3 |
| | 9 | 100 | 35 | 35 | 35000 | A | 0.5 | 13 | 5 | 2 | 5 | 3 |
| | 10 | 100 | 35 | 35 | 35000 | A | 0.5 | 13 | 5 | 2 | 5 | 3 |
| | 11 | 100 | 35 | 35 | 35000 | A | 0.5 | 13 | 5 | 2 | 5 | 3 |
| | 12 | 100 | 35 | 35 | 35000 | A | 0.5 | 13 | 5 | 2 | 5 | 3 |
| | 13 | 100 | 35 | 35 | 35000 | A | 0.5 | 13 | 5 | 2 | 5 | 3 |
| | 14 | 100 | 35 | 35 | 35000 | A | 0.5 | 13 | 5 | 2 | 5 | 3 |
| | 15 | 100 | 35 | 35 | 35000 | A | 0.5 | 13 | 5 | 2 | 5 | 3 |
| | 16 | 100 | 35 | 35 | 35000 | A | 0.5 | 13 | 5 | 2 | 5 | 3 |
| | 17 | 100 | 35 | 35 | 35000 | A | 0.5 | 13 | 5 | 2 | 5 | 3 |
| | 18 | 100 | 15 | 15 | 35000 | A | 0.5 | 13 | 5 | 2 | 5 | 3 |
| | 19 | 100 | 50 | 50 | 35000 | A | 0.5 | 13 | 5 | 2 | 5 | 3 |
| | 20 | 100 | 35 | 35 | 5000 | A | 0.5 | 13 | 5 | 2 | 5 | 3 |
| | 21 | 100 | 35 | 35 | 50000 | A | 0.5 | 13 | 5 | 2 | 5 | 3 |
| | 22 | 100 | 35 | 35 | 35000 | B | 0.5 | 13 | 5 | 2 | 5 | 3 |
| | 23 | 100 | 35 | 35 | 35000 | C | 0.5 | 13 | 5 | 2 | 5 | 3 |
| | 24 | 100 | 35 | 35 | 35000 | A | 0.2 | 13 | 5 | 2 | 5 | 3 |
| | 25 | 100 | 35 | 35 | 35000 | A | 1.0 | 13 | 5 | 2 | 5 | 3 |
| | 26 | 100 | 35 | 35 | 35000 | A | 0.5 | 8 | 5 | 2 | 5 | 3 |
| | 27 | 100 | 35 | 35 | 35000 | A | 0.5 | 18 | 5 | 2 | 5 | 3 |
| | 28 | 100 | 35 | 35 | 35000 | A | 0.5 | 13 | 1 | 2 | 5 | 3 |
| | 29 | 100 | 35 | 35 | 35000 | A | 0.5 | 13 | 10 | 2 | 5 | 3 |
| | 30 | 100 | 35 | 35 | 35000 | A | 0.5 | 13 | 5 | 1 | 5 | 3 |
| | 31 | 100 | 35 | 35 | 35000 | A | 0.5 | 13 | 5 | 4 | 5 | 3 |
| | 32 | 100 | 35 | 35 | 35000 | A | 0.5 | 13 | 5 | 2 | 1 | 3 |
| | 33 | 100 | 35 | 35 | 35000 | A | 0.5 | 13 | 5 | 2 | 9 | 3 |
| | 34 | 100 | 35 | 35 | 35000 | A | 0.5 | 13 | 5 | 2 | 5 | 1 |
| | 35 | 100 | 35 | 35 | 35000 | A | 0.5 | 13 | 5 | 2 | 5 | 7 |
| | 36 | 100 | 35 | 35 | 35000 | A | 0.5 | 13 | 5 | 2 | 5 | 10 |
| | 37 | 100 | 35 | 35 | 35000 | A | 0.5 | 13 | 5 | 2 | 5 | 3 |
| | 38 | 100 | 35 | 35 | 35000 | A | 0.5 | 13 | 5 | 2 | 5 | 3 |
| | 39 | 100 | 35 | 35 | 35000 | A | 0.5 | 13 | 5 | 2 | 5 | 3 |
| | 40 | 100 | 35 | 35 | 35000 | A | 0.5 | 13 | 5 | 2 | 5 | 3 |
| | 41 | 100 | 35 | 35 | 35000 | A | 0.5 | 13 | 5 | 2 | 5 | 3 |
| | 42 | 100 | 35 | 35 | 35000 | A | 0.5 | 13 | 5 | 2 | 5 | 3 |
| | 43 | 100 | 35 | 35 | 35000 | A | 0.5 | 13 | 5 | 2 | 5 | 3 |
| | 44 | 100 | 35 | 35 | 35000 | A | 0.5 | 13 | 5 | 2 | 5 | 3 |
| | 45 | 100 | 3 | 35 | 35000 | A | 0.5 | 13 | 5 | 2 | 5 | 3 |

Note 1
A: Diethanolamine
B: Ethylethanolamine
C: Dipropanolamine

TABLE 4-2

| | | The first composite coating | | | | | | | | | | |
|---|---|---|---|---|---|---|---|---|---|---|---|---|
| | | Coating composition | | | | | | Al powder | | | | |
| | | (parts by weight) | | | Amine-modified | | | Length | | | Ni | |
| | | Amine- | | | epoxy resin | | | of | Length | | powder | |
| | | modified | | | | Alkanolamine | | major | of minor | | Particle | Film |
| | | epoxy | Al | Ni | Weight | Kind | Addition | axis | axis | Thickness | diameter | thickness |
| Category | No. | resin | powder | powder | average | *Note 1 | amount | (μm) | (μm) | (μm) | (μm) | (μm) |
| Exampl | 46 | 100 | 35 | 35 | 35000 | A | 0.5 | 13 | 5 | 2 | 5 | 3 |
| | 47 | 100 | 35 | 35 | 35000 | A | 0.5 | 13 | 5 | 2 | 5 | 3 |
| | 48 | 100 | 35 | 35 | 35000 | A | 0.5 | 13 | 5 | 2 | 5 | 3 |
| | 49 | 100 | 35 | 35 | 35000 | A | 0.5 | 13 | 5 | 2 | 5 | 3 |
| | 50 | 100 | 35 | 35 | 35000 | A | 0.5 | 13 | 5 | 2 | 5 | 3 |
| | 51 | 100 | 35 | 35 | 35000 | A | 0.5 | 13 | 5 | 2 | 5 | 3 |
| | 52 | 100 | 35 | 35 | 35000 | A | 0.5 | 13 | 5 | 2 | 5 | 3 |
| | 53 | 100 | 35 | 35 | 35000 | A | 0.5 | 13 | 5 | 2 | 5 | 3 |
| | 54 | 100 | 35 | 35 | 35000 | A | 0.5 | 13 | 5 | 2 | 5 | 3 |
| | 55 | 100 | 35 | 35 | 35000 | A | 0.5 | 13 | 5 | 2 | 5 | 3 |
| | 56 | 100 | 35 | 35 | 35000 | A | 0.5 | 13 | 5 | 2 | 5 | 3 |
| | 57 | 100 | 35 | 35 | 35000 | A | 0.5 | 13 | 5 | 2 | 5 | 3 |
| | 58 | 100 | 35 | 35 | 35000 | A | 0.5 | 13 | 5 | 2 | 5 | 3 |
| | 59 | 100 | 35 | 35 | 35000 | A | 0.5 | 13 | 5 | 2 | 5 | 3 |
| | 60 | 100 | 35 | 35 | 35000 | A | 0.5 | 13 | 5 | 2 | 5 | 3 |
| | 61 | 100 | 35 | 35 | 35000 | A | 0.5 | 13 | 5 | 2 | 5 | 3 |
| | 62 | 100 | 35 | 35 | 35000 | A | 0.5 | 13 | 5 | 2 | 5 | 3 |
| | 63 | 100 | 35 | 35 | 35000 | A | 0.5 | 13 | 5 | 2 | 5 | 3 |
| | 64 | 100 | 35 | 35 | 35000 | A | 0.5 | 13 | 5 | 2 | 5 | 3 |
| | 65 | 100 | 35 | 35 | 35000 | A | 0.5 | 13 | 5 | 2 | 5 | 3 |
| | 66 | 100 | 35 | 35 | 35000 | A | 0.5 | 13 | 5 | 2 | 5 | 3 |
| | 67 | 100 | 35 | 35 | 35000 | A | 0.5 | 13 | 5 | 2 | 5 | 3 |
| | 68 | 100 | 35 | 35 | 35000 | A | 0.5 | 13 | 5 | 2 | 5 | 3 |
| | 69 | 100 | 35 | 35 | 35000 | A | 0.5 | 13 | 5 | 2 | 5 | 3 |
| | 70 | 100 | 35 | 35 | 35000 | A | 0.5 | 13 | 5 | 2 | 5 | 3 |
| | 71 | 100 | 35 | 35 | 35000 | A | 0.5 | 13 | 5 | 2 | 5 | 3 |
| | 72 | 100 | 35 | 35 | 35000 | A | 0.5 | 13 | 5 | 2 | 5 | 3 |
| | 73 | 100 | 35 | 35 | 35000 | A | 0.5 | 13 | 5 | 2 | 5 | 3 |
| | 74 | 100 | 35 | 35 | 35000 | A | 0.5 | 13 | 5 | 2 | 5 | 3 |
| | 75 | 100 | 35 | 35 | 35000 | A | 0.5 | 13 | 5 | 2 | 5 | 3 |
| | 76 | 100 | 35 | 35 | 35000 | A | 0.5 | 13 | 5 | 2 | 5 | 3 |
| | 77 | 100 | 35 | 35 | 35000 | A | 0.5 | 13 | 5 | 2 | 5 | 3 |
| | 78 | 100 | 35 | 35 | 35000 | A | 0.5 | 13 | 5 | 2 | 5 | 3 |
| | 79 | 100 | 35 | 35 | 35000 | A | 0.5 | 13 | 5 | 2 | 5 | 3 |
| | 80 | 100 | 35 | 35 | 35000 | A | 0.5 | 13 | 5 | 2 | 5 | 3 |
| | 81 | 100 | 35 | 35 | 35000 | A | 0.5 | 13 | 5 | 2 | 5 | 3 |
| | 82 | 100 | 35 | 35 | 35000 | A | 0.5 | 13 | 5 | 2 | 5 | 3 |
| | 83 | 100 | 35 | 35 | 35000 | A | 0.5 | 13 | 5 | 2 | 5 | 3 |
| | 84 | 100 | 35 | 35 | 35000 | A | 0.5 | 13 | 5 | 2 | 5 | 3 |
| | 85 | 100 | 35 | 35 | 35000 | A | 0.5 | 13 | 5 | 2 | 5 | 3 |
| | 86 | 100 | 35 | 35 | 35000 | A | 0.5 | 13 | 5 | 2 | 5 | 3 |
| | 87 | 100 | 35 | 35 | 35000 | A | 0.5 | 13 | 5 | 2 | 5 | 3 |
| | 88 | 100 | 35 | 35 | 35000 | A | 0.5 | 13 | 5 | 2 | 5 | 3 |
| | 89 | 100 | 35 | 35 | 35000 | A | 0.5 | 13 | 5 | 2 | 5 | 3 |
| | 90 | 100 | 35 | 15 | 35000 | A | 0.5 | 13 | 5 | 2 | 5 | 3 |

Note 1
A: Diethanolamine
B: Ethylethanolamine
C: Dipropanolamine

TABLE 5-1

| | | The first composite coating | | | | | | | | | | |
|---|---|---|---|---|---|---|---|---|---|---|---|---|
| | | Coating composition | | | | | | Al powder | | | | |
| | | (parts by weight) | | | Amine-modified | | | Length | | | Ni | |
| | | Amine- | | | epoxy resin | | | of | Length | | powder | |
| | | modified | | | | Alkanolamine | | major | of minor | | Particle | Film |
| | | epoxy | Al | Ni | Weight | Kind | Addition | axis | axis | Thickness | diameter | thickness |
| Category | No. | resin | powder | powder | average | *Note 1 | amount | (μm) | (μm) | (μm) | (μm) | (μm) |
| Exampl | 91 | 100 | 35 | 50 | 35000 | A | 0.5 | 13 | 5 | 2 | 5 | 3 |
| | 92 | 100 | 35 | 35 | 5000 | A | 0.5 | 13 | 5 | 2 | 5 | 3 |
| | 93 | 100 | 35 | 35 | 50000 | A | 0.5 | 13 | 5 | 2 | 5 | 3 |
| | 94 | 100 | 35 | 35 | 35000 | B | 0.5 | 13 | 5 | 2 | 5 | 3 |
| | 95 | 100 | 35 | 35 | 35000 | C | 0.5 | 13 | 5 | 2 | 5 | 3 |
| | 96 | 100 | 35 | 35 | 35000 | A | 0.2 | 13 | 5 | 2 | 5 | 3 |
| | 97 | 100 | 35 | 35 | 35000 | A | 1.0 | 13 | 5 | 2 | 5 | 3 |
| | 98 | 100 | 35 | 35 | 35000 | A | 0.5 | 8 | 5 | 2 | 5 | 3 |
| | 99 | 100 | 35 | 35 | 35000 | A | 0.5 | 18 | 5 | 2 | 5 | 3 |
| | 100 | 100 | 35 | 35 | 35000 | A | 0.5 | 13 | 1 | 2 | 5 | 3 |
| | 101 | 100 | 35 | 35 | 35000 | A | 0.5 | 13 | 10 | 2 | 5 | 3 |
| | 102 | 100 | 35 | 35 | 35000 | A | 0.5 | 13 | 5 | 1 | 5 | 3 |
| | 103 | 100 | 35 | 35 | 35000 | A | 0.5 | 13 | 5 | 4 | 5 | 3 |
| | 104 | 100 | 35 | 35 | 35000 | A | 0.5 | 13 | 5 | 2 | 1 | 3 |
| | 105 | 100 | 35 | 35 | 35000 | A | 0.5 | 13 | 5 | 2 | 9 | 3 |
| | 106 | 100 | 35 | 35 | 35000 | A | 0.5 | 13 | 5 | 2 | 5 | 1 |
| | 107 | 100 | 35 | 35 | 35000 | A | 0.5 | 13 | 5 | 2 | 5 | 7 |
| | 108 | 100 | 35 | 35 | 35000 | A | 0.5 | 13 | 5 | 2 | 5 | 10 |
| | 109 | 100 | 35 | 35 | 35000 | A | 0.5 | 13 | 5 | 2 | 5 | 3 |
| | 110 | 100 | 35 | 35 | 35000 | A | 0.5 | 13 | 5 | 2 | 5 | 3 |
| | 111 | 100 | 35 | 35 | 35000 | A | 0.5 | 13 | 5 | 2 | 5 | 3 |
| | 112 | 100 | 35 | 35 | 35000 | A | 0.5 | 13 | 5 | 2 | 5 | 3 |
| | 113 | 100 | 35 | 35 | 35000 | A | 0.5 | 13 | 5 | 2 | 5 | 3 |
| | 114 | 100 | 35 | 35 | 35000 | A | 0.5 | 13 | 5 | 2 | 5 | 3 |
| | 115 | 100 | 35 | 35 | 35000 | A | 0.5 | 13 | 5 | 2 | 5 | 3 |
| | 116 | 100 | 35 | 35 | 35000 | A | 0.5 | 13 | 5 | 2 | 5 | 3 |
| | 117 | 100 | 35 | 35 | 35000 | A | 0.5 | 13 | 5 | 2 | 5 | 3 |
| | 118 | 100 | 35 | 35 | 35000 | A | 0.5 | 13 | 5 | 2 | 5 | 3 |
| | 119 | 100 | 35 | 35 | 35000 | A | 0.5 | 13 | 5 | 2 | 5 | 3 |
| | 120 | 100 | 35 | 35 | 35000 | A | 0.5 | 13 | 5 | 2 | 5 | 3 |
| | 121 | 100 | 35 | 35 | 35000 | A | 0.5 | 13 | 5 | 2 | 5 | 3 |
| | 122 | 100 | 35 | 35 | 35000 | A | 0.5 | 13 | 5 | 2 | 5 | 3 |
| | 123 | 100 | 35 | 35 | 35000 | A | 0.5 | 13 | 5 | 2 | 5 | 3 |
| | 124 | 100 | 35 | 35 | 35000 | A | 0.5 | 13 | 5 | 2 | 5 | 3 |
| | 125 | 100 | 35 | 35 | 35000 | A | 0.5 | 13 | 5 | 2 | 5 | 3 |
| | 126 | 100 | 35 | 35 | 35000 | A | 0.5 | 13 | 5 | 2 | 5 | 3 |
| | 127 | 100 | 35 | 35 | 35000 | A | 0.5 | 13 | 5 | 2 | 5 | 3 |
| | 128 | 100 | 35 | 35 | 35000 | A | 0.5 | 13 | 5 | 2 | 5 | 3 |
| | 129 | 100 | 35 | 35 | 35000 | A | 0.5 | 13 | 5 | 2 | 5 | 3 |
| | 130 | 100 | 35 | 35 | 35000 | A | 0.5 | 13 | 5 | 2 | 5 | 3 |
| | 131 | 100 | 35 | 35 | 35000 | A | 0.5 | 13 | 5 | 2 | 5 | 3 |
| | 132 | 100 | 35 | 35 | 35000 | A | 0.5 | 13 | 5 | 2 | 5 | 3 |
| | 133 | 100 | 35 | 35 | 35000 | A | 0.5 | 13 | 5 | 2 | 5 | 3 |

Note 1
A: Diethanolamine
B: Ethylethanolamine
C: Dipropanolamine

TABLE 5-2

| | | The first composite coating | | | | | | | | | | |
|---|---|---|---|---|---|---|---|---|---|---|---|---|
| | | Coating composition | | | | | | Al powder | | | | |
| | | (parts by weight) | | | Amine-modified | | | Length | | | Ni | |
| | | Amine- | | | epoxy resin | | | of | Length | | powder | |
| | | modified | | | | Alkanolamine | | major | of minor | | Particle | Film |
| | | epoxy | Al | Ni | Weight | Kind | Addition | axis | axis | Thickness | diameter | thickness |
| Category | No. | resin | powder | powder | average | *Note 1 | amount | (μm) | (μm) | (μm) | (μm) | (μm) |
| Example | 134 | 100 | 35 | 35 | 3500 | A | 0.5 | 13 | 5 | 2 | 5 | 3 |
| | 135 | 100 | 35 | 35 | 3500 | A | 0.5 | 13 | 5 | 2 | 5 | 3 |
| | 136 | 100 | 35 | 35 | 3500 | A | 0.5 | 13 | 5 | 2 | | 3 |
| Comparat | 1 | 100 | 35 | 35 | 3500 | A | 0.5 | 13 | 5 | 2 | 5 | 3 |
| Example | 2 | 100 | 35 | 35 | 3500 | A | 0.5 | 13 | 5 | 2 | 5 | 3 |
| | 3 | 100 | 35 | 35 | 3500 | A | 0.5 | 13 | 5 | 2 | 5 | 3 |
| | 4 | 100 | 0 | 0 | 3500 | A | 0.5 | 13 | 5 | 2 | 5 | 3 |
| | 5 | 100 | 35 | 35 | 3500 | A | 0 | 13 | 5 | 2 | 5 | 3 |
| | 6 | 100 | 35 | 35 | 3500 | A | 0.5 | 13 | 5 | 2 | 5 | 3 |
| | 7 | 100 | 35 | 35 | 3500 | A | 0.5 | 13 | 5 | 2 | 5 | 3 |
| | 8 | 100 | 35 | 35 | 3500 | A | 0.5 | 13 | 5 | 2 | 5 | 3 |
| | 9 | None | | | | | | | | | | |
| | 10 | None | | | | | | | | | | |
| | 11 | Indicated by (a) as shown in Table 11 | | | | | | | | | | 3 |
| | 12 | Indicated by (b) as shown in Table 11 | | | | | | | | | | 3 |
| | 13 | Indicated by (c) as shown in Table 11 | | | | | | | | | | 3 |
| | 14 | Indicated by (d) as shown in Table 11 | | | | | | | | | | 3 |
| | 15 | 100 | 35 | 35 | 3500 | A | 0.5 | 13 | 5 | 2 | 5 | 3 |
| | 16 | 100 | 35 | 35 | 3500 | A | 0.5 | 13 | 5 | 2 | 5 | 3 |
| | 17 | 100 | 35 | 35 | 3500 | A | 0.5 | 13 | 5 | 2 | 5 | 3 |
| | 18 | 100 | 35 | 35 | 3500 | A | 0.5 | 13 | 5 | 2 | 5 | 3 |
| | 19 | 100 | 0 | 0 | 3500 | A | 0.5 | 13 | 5 | 2 | 5 | 3 |
| | 20 | 100 | 35 | 35 | 3500 | A | 0 | 13 | 5 | 2 | 5 | 3 |
| | 21 | 100 | 35 | 35 | 3500 | A | 0.5 | 13 | 5 | 2 | 5 | 3 |
| | 22 | 100 | 35 | 35 | 3500 | A | 0.5 | 13 | 5 | 2 | 5 | 3 |
| | 23 | 100 | 35 | 35 | 3500 | A | 0.5 | 13 | 5 | 2 | 5 | 3 |
| | 24 | 100 | 35 | 35 | 3500 | A | 0.5 | 13 | 5 | 2 | 5 | 3 |
| | 25 | 100 | 35 | 35 | 3500 | A | 0.5 | 13 | 5 | 2 | 5 | 3 |
| | 26 | 100 | 35 | 35 | 3500 | A | 0.5 | 13 | 5 | 2 | 5 | 3 |
| | 27 | 100 | 35 | 35 | 3500 | A | 0.5 | 13 | 5 | 2 | 5 | 3 |
| | 28 | 100 | 35 | 35 | 3500 | A | 0.5 | 13 | 5 | 2 | 5 | 3 |
| | 29 | 100 | 35 | 35 | 3500 | A | 0.5 | 13 | 5 | 2 | 5 | 3 |
| | 30 | 100 | 35 | 35 | 3500 | A | 0.5 | 13 | 5 | 2 | 5 | 3 |
| | 31 | 100 | 35 | 35 | 3500 | A | 0.5 | 13 | 5 | 2 | 5 | 3 |
| | 32 | 100 | 35 | 35 | 3500 | A | 0.5 | 13 | 5 | 2 | 5 | 3 |
| | 33 | 100 | 35 | 35 | 3500 | A | 0.5 | 13 | 5 | 2 | 5 | 3 |

| 34 | None | |
|---|---|---|
| 35 | None | |
| 36 | Indicated by (a) as shown in Table 11 | 3 |
| 37 | Indicated by (b) as shown in Table 11 | 3 |
| 38 | Indicated by (c) as shown in Table 11 | 3 |
| 39 | Indicated by (d) as shown in Table 11 | 3 |

Note 1
A: Diethanolamine
B: Ethylethanolamine
C: Dipropanolamine

TABLE 6-1

| | | The first composite coating | | | | | | | | | | |
|---|---|---|---|---|---|---|---|---|---|---|---|---|
| | | Coating composition | | | | | | Al powder | | | | |
| | | (parts by weight) | | | Amine-modified | | | Length | | | Ni | |
| | | Amine- | | | epoxy resin | | | of | Length | | powder | |
| | | modified | | | | Alkanolamine | | major | of minor | | Particle | Film |
| | | epoxy | Al | Ni | Weight | Kind | Addition | axis | axis | Thickness | diameter | thickness |
| Category | No. | resin | powder | powder | average | *Note 1 | amount | (μm) | (μm) | (μm) | (μm) | (μm) |
| Exampl | 1 | 100 | 10 | 30 | 10 | A | 80 | 120 | 2 | A | 0.5 | 1 |
| | 2 | 100 | 10 | 30 | 10 | A | 80 | 120 | 2 | A | 0.5 | 1 |
| | 3 | 100 | 10 | 30 | 10 | A | 80 | 120 | 2 | A | 0.5 | 1 |
| | 4 | 100 | 10 | 30 | 10 | A | 80 | 120 | 2 | A | 0.5 | 1 |
| | 5 | 100 | 10 | 30 | 10 | A | 80 | 120 | 2 | A | 0.5 | 1 |
| | 6 | 100 | 10 | 30 | 10 | A | 80 | 120 | 2 | A | 0.5 | 1 |
| | 7 | 100 | 10 | 30 | 10 | A | 80 | 120 | 2 | A | 0.5 | 1 |
| | 8 | 100 | 10 | 30 | 10 | A | 80 | 120 | 2 | A | 0.5 | 1 |
| | 9 | 100 | 10 | 30 | 10 | A | 80 | 120 | 2 | A | 0.5 | 1 |
| | 10 | 100 | 10 | 30 | 10 | A | 80 | 120 | 2 | A | 0.5 | 1 |
| | 11 | 100 | 10 | 30 | 10 | A | 80 | 120 | 2 | A | 0.5 | 1 |
| | 12 | 100 | 10 | 30 | 10 | A | 80 | 120 | 2 | A | 0.5 | 1 |
| | 13 | 100 | 10 | 30 | 10 | A | 80 | 120 | 2 | A | 0.5 | 1 |
| | 14 | 100 | 10 | 30 | 10 | A | 80 | 120 | 2 | A | 0.5 | 1 |
| | 15 | 100 | 10 | 30 | 10 | A | 80 | 120 | 2 | A | 0.5 | 1 |
| | 16 | 100 | 10 | 30 | 10 | A | 80 | 120 | 2 | A | 0.5 | 1 |
| | 17 | 100 | 10 | 30 | 10 | A | 80 | 120 | 2 | A | 0.5 | 1 |
| | 18 | 100 | 10 | 30 | 10 | A | 80 | 120 | 2 | A | 0.5 | 1 |
| | 19 | 100 | 10 | 30 | 10 | A | 80 | 120 | 2 | A | 0.5 | 1 |
| | 20 | 100 | 10 | 30 | 10 | A | 80 | 120 | 2 | A | 0.5 | 1 |
| | 21 | 100 | 10 | 30 | 10 | A | 80 | 120 | 2 | A | 0.5 | 1 |
| | 22 | 100 | 10 | 30 | 10 | A | 80 | 120 | 2 | A | 0.5 | 1 |
| | 23 | 100 | 10 | 30 | 10 | A | 80 | 120 | 2 | A | 0.5 | 1 |
| | 24 | 100 | 10 | 30 | 10 | A | 80 | 120 | 2 | A | 0.5 | 1 |
| | 25 | 100 | 10 | 30 | 10 | A | 80 | 120 | 2 | A | 0.5 | 1 |
| | 26 | 100 | 10 | 30 | 10 | A | 80 | 120 | 2 | A | 0.5 | 1 |
| | 27 | 100 | 10 | 30 | 10 | A | 80 | 120 | 2 | A | 0.5 | 1 |
| | 28 | 100 | 10 | 30 | 10 | A | 80 | 120 | 2 | A | 0.5 | 1 |
| | 29 | 100 | 10 | 30 | 10 | A | 80 | 120 | 2 | A | 0.5 | 1 |
| | 30 | 100 | 10 | 30 | 10 | A | 80 | 120 | 2 | A | 0.5 | 2. |
| | 31 | 100 | 10 | 30 | 10 | A | 80 | 120 | 2 | A | 0.5 | 1 |
| | 32 | 100 | 10 | 30 | 10 | A | 80 | 120 | 2 | A | 0.5 | 1 |
| | 33 | 100 | 10 | 30 | 10 | A | 80 | 120 | 2 | A | 0.5 | 1 |
| | 34 | 100 | 10 | 30 | 10 | A | 80 | 120 | 2 | A | 0.5 | 1 |
| | 35 | 100 | 10 | 30 | 10 | A | 80 | 120 | 2 | A | 0.5 | 1 |
| | 36 | 100 | 10 | 30 | 10 | A | 80 | 120 | 2 | A | 0.5 | 1 |
| | 37 | 100 | 5 | 30 | 10 | A | 80 | 120 | 2 | A | 0.5 | 1 |
| | 38 | 100 | 80 | 30 | 10 | A | 80 | 120 | 2 | A | 0.5 | 1 |
| | 39 | 100 | 10 | 1 | 10 | A | 80 | 120 | 2 | A | 0.5 | 1 |
| | 40 | 100 | 10 | 40 | 10 | A | 80 | 120 | 2 | A | 0.5 | 1 |
| | 41 | 100 | 10 | 30 | 5 | A | 80 | 120 | 2 | A | 0.5 | 1 |
| | 42 | 100 | 10 | 30 | 25 | A | 80 | 120 | 2 | A | 0.5 | 1 |
| | 43 | 100 | 10 | 30 | 10 | B | 80 | 120 | 2 | A | 0.5 | 1 |
| | 44 | 100 | 10 | 30 | 10 | C | 80 | 120 | 2 | A | 0.5 | 1 |
| | 45 | 100 | 10 | 30 | 10 | D | 80 | 120 | 2 | A | 0.5 | 1 |

Note 1
A: Polyurethane
B: Alkyd
C: Acryl
D: Urethane
E: Acrylurethane
Note 2
A: SN100D
B: Nano Tek Tinoxide
C: CELAMASE S-8
D: CELNAX CX-Z300H
E: AUP
F: Hitasol GA-66

TABLE 6-2

| | | The second composite coating | | | | | | | | | | |
|---|---|---|---|---|---|---|---|---|---|---|---|---|
| | | | | | | | | Polyolefin wax | | Conductive particle | | |
| | | | | | | | | | Average | | Average | |
| | | Coating composition (parts by weight) | | | | Resin | | Softening | particle | | particle | Film |
| | | | | Polyolefin | Conductive | Kind | Tg | point | diameter | Kind | diameter | thickness |
| Category | No. | Resin | Silica | wax | particle | *Note 1 | (° C.) | (° C.) | (μm) | *Note 2 | (μm) | (μm) |
| Exampl | 46 | 100 | 10 | 30 | 10 | E | 80 | 120 | 2 | A | 0.5 | 1 |
| | 47 | 100 | 10 | 30 | 10 | A | 0 | 120 | 2 | A | 0.5 | 1 |
| | 48 | 100 | 10 | 30 | 10 | A | 90 | 120 | 2 | A | 0.5 | 1 |
| | 49 | 100 | 10 | 30 | 10 | A | 80 | 70 | 2 | A | 0.5 | 1 |
| | 50 | 100 | 10 | 30 | 10 | A | 80 | 50 | 2 | A | 0.5 | 1 |
| | 51 | 100 | 10 | 30 | 10 | A | 80 | 120 | 1 | A | 0.5 | 1 |
| | 52 | 100 | 10 | 30 | 10 | A | 80 | 120 | 7 | A | 0.5 | 1 |
| | 53 | 100 | 10 | 30 | 10 | A | 80 | 120 | 2 | B | 0.5 | 1 |
| | 54 | 100 | 10 | 30 | 10 | A | 80 | 120 | 2 | C | 0.5 | 1 |
| | 55 | 100 | 10 | 30 | 10 | A | 80 | 120 | 2 | D | 0.5 | 1 |
| | 56 | 100 | 10 | 30 | 10 | A | 80 | 120 | 2 | E | 0.5 | 1 |
| | 57 | 100 | 10 | 30 | 10 | A | 80 | 120 | 2 | F | 0.5 | 1 |
| | 58 | 100 | 10 | 30 | 10 | A | 80 | 120 | 2 | A | 0.1 | 1 |
| | 59 | 100 | 10 | 30 | 10 | A | 80 | 120 | 2 | A | 2 | 1 |
| | 60 | 100 | 10 | 30 | 10 | A | 80 | 120 | 2 | A | 0.5 | 0.3 |
| | 61 | 100 | 10 | 30 | 10 | A | 80 | 120 | 2 | A | 0.5 | 0.5 |
| | 62 | 100 | 10 | 30 | 10 | A | 80 | 120 | 2 | A | 0.5 | 1.9 |
| | 63 | 100 | 10 | 30 | 10 | A | −20 | 120 | 2 | A | 0.5 | 1 |
| | 64 | 100 | 10 | 30 | 10 | A | 98 | 120 | 2 | A | 0.5 | 1 |
| | 65 | 100 | 10 | 30 | 10 | A | 80 | 55 | 2 | A | 0.5 | 1 |
| | 66 | 100 | 10 | 30 | 10 | A | 80 | 165 | 2 | A | 0.5 | 1 |
| | 67 | 100 | 10 | 30 | 10 | A | 80 | 120 | 0.5 | A | 0.5 | 1 |
| | 68 | 100 | 10 | 30 | 10 | A | 80 | 120 | 8 | A | 0.5 | 1 |
| | 69 | 100 | 10 | 30 | 10 | A | 80 | 120 | 2 | A | 0.008 | 1 |
| | 70 | 100 | 10 | 30 | 10 | A | 80 | 120 | 2 | A | 4.0 | 1 |
| | 71 | 100 | 10 | 30 | 10 | A | 80 | 120 | 2 | A | 0.5 | 0.01 |
| | 72 | 100 | 10 | 30 | 10 | A | 80 | 120 | 2 | A | 0.5 | 2.5 |
| | 73 | 100 | 10 | 30 | 10 | A | 80 | 120 | 2 | A | 0.5 | 1 |
| | 74 | 100 | 10 | 30 | 10 | A | 80 | 120 | 2 | A | 0.5 | 1 |
| | 75 | 100 | 10 | 30 | 10 | A | 80 | 120 | 2 | A | 0.5 | 1 |
| | 76 | 100 | 10 | 30 | 10 | A | 80 | 120 | 2 | A | 0.5 | 1 |
| | 77 | 100 | 10 | 30 | 10 | A | 80 | 120 | 2 | A | 0.5 | 1 |
| | 78 | 100 | 10 | 30 | 10 | A | 80 | 120 | 2 | A | 0.5 | 1 |
| | 79 | 100 | 10 | 30 | 10 | A | 80 | 120 | 2 | A | 0.5 | 1 |
| | 80 | 100 | 10 | 30 | 10 | A | 80 | 120 | 2 | A | 0.5 | 1 |
| | 81 | 100 | 10 | 30 | 10 | A | 80 | 120 | 2 | A | 0.5 | 1 |
| | 82 | 100 | 10 | 30 | 10 | A | 80 | 120 | 2 | A | 0.5 | 1 |
| | 83 | 100 | 10 | 30 | 10 | A | 80 | 120 | 2 | A | 0.5 | 1 |
| | 84 | 100 | 10 | 30 | 10 | A | 80 | 120 | 2 | A | 0.5 | 1 |
| | 85 | 100 | 10 | 30 | 10 | A | 80 | 120 | 2 | A | 0.5 | 1 |
| | 86 | 100 | 10 | 30 | 10 | A | 80 | 120 | 2 | A | 0.5 | 1 |
| | 87 | 100 | 10 | 30 | 10 | A | 80 | 120 | 2 | A | 0.5 | 1 |
| | 88 | 100 | 10 | 30 | 10 | A | 80 | 120 | 2 | A | 0.5 | 1 |
| | 89 | 100 | 10 | 30 | 10 | A | 80 | 120 | 2 | A | 0.5 | 1 |
| | 90 | 100 | 10 | 30 | 10 | A | 80 | 120 | 2 | A | 0.5 | 1 |

(Note 1)
A: Polyurethane
B: Alkyd
C: Acryl
D: Urethane
E: Acrylurethane
(Note 2)
A: SN100D
B: Nano Tek Tinoxide
C: CELAMASE S-8
D: CELNAX CX-Z300H
E: AUP
F: Hitasol GA-66

TABLE 7-1

| | | The second composite coating | | | | | | | | | | |
|---|---|---|---|---|---|---|---|---|---|---|---|---|
| | | | | | | | | Polyolefin wax | | Conductive particle | | |
| | | | | | | | | | Average | | Average | |
| | | Coating composition (parts by weight) | | | | Resin | | Softening | particle | | particle | Film |
| | | | | Polyolefin | Conductive | Kind | Tg | point | diameter | Kind | diameter | thickness |
| Category | No. | Resin | Silica | wax | particle | *Note 1 | (° C.) | (° C.) | (μm) | *Note 2 | (μm) | (μm) |
| Exampl | 91 | 100 | 10 | 30 | 10 | A | 80 | 120 | 2 | A | 0.5 | 1 |
| | 92 | 100 | 10 | 30 | 10 | A | 80 | 120 | 2 | A | 0.5 | 1 |
| | 93 | 100 | 10 | 30 | 10 | A | 80 | 120 | 2 | A | 0.5 | 1 |
| | 94 | 100 | 10 | 30 | 10 | A | 80 | 120 | 2 | A | 0.5 | 1 |
| | 95 | 100 | 10 | 30 | 10 | A | 80 | 120 | 2 | A | 0.5 | 1 |
| | 96 | 100 | 10 | 30 | 10 | A | 80 | 120 | 2 | A | 0.5 | 1 |
| | 97 | 100 | 10 | 30 | 10 | A | 80 | 120 | 2 | A | 0.5 | 1 |
| | 98 | 100 | 10 | 30 | 10 | A | 80 | 120 | 2 | A | 0.5 | 1 |
| | 99 | 100 | 10 | 30 | 10 | A | 80 | 120 | 2 | A | 0.5 | 1 |
| | 100 | 100 | 10 | 30 | 10 | A | 80 | 120 | 2 | A | 0.5 | 1 |
| | 101 | 100 | 10 | 30 | 10 | A | 80 | 120 | 2 | A | 0.5 | 1 |
| | 102 | 100 | 10 | 30 | 10 | A | 80 | 120 | 2 | A | 0.5 | 1 |
| | 103 | 100 | 10 | 30 | 10 | A | 80 | 120 | 2 | A | 0.5 | 1 |
| | 104 | 100 | 10 | 30 | 10 | A | 80 | 120 | 2 | A | 0.5 | 1 |
| | 105 | 100 | 10 | 30 | 10 | A | 80 | 120 | 2 | A | 0.5 | 1 |
| | 106 | 100 | 10 | 30 | 10 | A | 80 | 120 | 2 | A | 0.5 | 1 |
| | 107 | 100 | 10 | 30 | 10 | A | 80 | 120 | 2 | A | 0.5 | 1 |
| | 108 | 100 | 10 | 30 | 10 | A | 80 | 120 | 2 | A | 0.5 | 1 |
| | 109 | 100 | 5 | 30 | 10 | A | 80 | 120 | 2 | A | 0.5 | 1 |
| | 110 | 100 | 80 | 30 | 10 | A | 80 | 120 | 2 | A | 0.5 | 1 |
| | 111 | 100 | 10 | 1 | 10 | A | 80 | 120 | 2 | A | 0.5 | 1 |
| | 112 | 100 | 10 | 40 | 10 | A | 80 | 120 | 2 | A | 0.5 | 1 |
| | 113 | 100 | 10 | 30 | 5 | A | 80 | 120 | 2 | A | 0.5 | 1 |
| | 114 | 100 | 10 | 30 | 25 | A | 80 | 120 | 2 | A | 0.5 | 1 |
| | 115 | 100 | 10 | 30 | 10 | B | 80 | 120 | 2 | A | 0.5 | 1 |
| | 116 | 100 | 10 | 30 | 10 | C | 80 | 120 | 2 | A | 0.5 | 1 |
| | 117 | 100 | 10 | 30 | 10 | D | 80 | 120 | 2 | A | 0.5 | 1 |
| | 118 | 100 | 10 | 30 | 10 | E | 80 | 120 | 2 | A | 0.5 | 1 |
| | 119 | 100 | 10 | 30 | 10 | A | 0 | 120 | 2 | A | 0.5 | 1 |
| | 120 | 100 | 10 | 30 | 10 | A | 90 | 120 | 2 | A | 0.5 | 1 |
| | 121 | 100 | 10 | 30 | 10 | A | 80 | 70 | 2 | A | 0.5 | 1 |
| | 122 | 100 | 10 | 30 | 10 | A | 80 | 50 | 2 | A | 0.5 | 1 |
| | 123 | 100 | 10 | 30 | 10 | A | 80 | 120 | 1 | A | 0.5 | 1 |
| | 124 | 100 | 10 | 30 | 10 | A | 80 | 120 | 7 | A | 0.5 | 1 |
| | 125 | 100 | 10 | 30 | 10 | A | 80 | 120 | 2 | B | 0.5 | 1 |
| | 126 | 100 | 10 | 30 | 10 | A | 80 | 120 | 2 | C | 0.5 | 1 |
| | 127 | 100 | 10 | 30 | 10 | A | 80 | 120 | 2 | D | 0.5 | 1 |
| | 128 | 100 | 10 | 30 | 10 | A | 80 | 120 | 2 | E | 0.5 | 1 |
| | 129 | 100 | 10 | 30 | 10 | A | 80 | 120 | 2 | F | 0.5 | 1 |
| | 130 | 100 | 10 | 30 | 10 | A | 80 | 120 | 2 | A | 0.1 | 1 |
| | 131 | 100 | 10 | 30 | 10 | A | 80 | 120 | 2 | A | 2 | 1 |
| | 132 | 100 | 10 | 30 | 10 | A | 80 | 120 | 2 | A | 0.5 | 0.3 |
| | 133 | 100 | 10 | 30 | 10 | A | 80 | 120 | 2 | A | 0.5 | 0.5 |

(Note 1)
A: Polyurethane
B: Alkyd
C: Acryl
D: Urethane
E: Acrylurethane
(Note 2)
A: SN100D
B: Nano Tek Tinoxide
C: CELAMASE S-8
D: CELNAX CX-Z300H
E: AUP
F: Hitasol GA-66

TABLE 7-2

| | | The second composite coating | | | | | | | | | | |
|---|---|---|---|---|---|---|---|---|---|---|---|---|
| | | | | | | | | Polyolefin wax | | Conductive particle | | |
| | | | | | | | | | Average | | Average | |
| | | Coating composition (parts by weight) | | | | Resin | | Softening | particle | | particle | Film |
| | | | | Polyolefin | Conductive | Kind | Tg | point | diameter | Kind | diameter | thickness |
| Category | No. | Resin | Silica | wax | particle | *Note 1 | (° C.) | (° C.) | (μm) | *Note 2 | (μm) | (μm) |
| Example | 134 | 100 | 10 | 30 | 10 | A | 80 | 120 | 2 | A | 0.5 | 1.9 |
| | 135 | 100 | 10 | 30 | 10 | A | 80 | 120 | 2 | A | 0.5 | 1 |
| | 136 | 100 | 10 | 30 | 10 | A | 80 | 120 | 2 | A | 0.5 | 1 |
| Comparati | 1 | 100 | 10 | 30 | 10 | A | 80 | 120 | 2 | None | None | 1 |
| Example | 2 | 100 | 10 | 30 | 10 | A | 80 | 120 | 2 | A | 0.5 | 1 |
| | 3 | 100 | 10 | 30 | 10 | A | 80 | 120 | 2 | A | 0.5 | 1 |
| | 4 | 100 | 10 | 30 | 10 | A | 80 | 120 | 2 | A | 0.5 | 1 |
| | 5 | 100 | 10 | 30 | 10 | A | 80 | 120 | 2 | A | 0.5 | 1 |
| | 6 | 100 | 0 | 30 | 10 | A | 80 | 120 | 2 | A | 0.5 | 1 |
| | 7 | 100 | 10 | 0 | 10 | A | 80 | 120 | 2 | A | 0.5 | 1 |
| | 8 | 100 | 10 | 30 | 0 | A | 80 | 120 | 2 | A | 0.5 | 1 |
| | 9 | None | | | | | | | | | | |
| | 10 | None | | | | | | | | | | |
| | 11 | Indicated by (a) as shown in Table 11 | | | | | | | | | | 3 |
| | 12 | Indicated by (b) as shown in Table 11 | | | | | | | | | | 3 |
| | 13 | Indicated by (c) as shown in Table 11 | | | | | | | | | | 3 |
| | 14 | Indicated by (d) as shown in Table 11 | | | | | | | | | | 3 |
| | 15 | 100 | 10 | 30 | 10 | A | 80 | 120 | 2 | A | 0.5 | 1 |
| | 16 | 100 | 10 | 30 | 10 | A | 80 | 120 | 2 | A | 0.5 | 1 |
| | 17 | 100 | 10 | 30 | 10 | A | 80 | 120 | 2 | A | 0.5 | 1 |
| | 18 | 100 | 10 | 30 | 10 | A | 80 | 120 | 2 | A | 0.5 | 1 |
| | 19 | 100 | 10 | 30 | 10 | A | 80 | 120 | 2 | A | 0.5 | 1 |
| | 20 | 100 | 10 | 30 | 10 | A | 80 | 120 | 2 | A | 0.5 | 1 |
| | 21 | 100 | 0 | 30 | 10 | A | 80 | 120 | 2 | A | 0.5 | 1 |
| | 22 | 100 | 10 | 0 | 10 | A | 80 | 120 | 2 | A | 0.5 | 1 |
| | 23 | 100 | 10 | 30 | 0 | A | 80 | 120 | 2 | A | 0.5 | 1 |
| | 24 | 100 | 10 | 30 | 10 | A | −20 | 120 | 2 | A | 0.5 | 1 |
| | 25 | 100 | 10 | 30 | 10 | A | 98 | 120 | 2 | A | 0.5 | 1 |
| | 26 | 100 | 10 | 30 | 10 | A | 80 | 55 | 2 | A | 0.5 | 1 |
| | 27 | 100 | 10 | 30 | 10 | A | 80 | 165 | 2 | A | 0.5 | 1 |
| | 28 | 100 | 10 | 30 | 10 | A | 80 | 120 | 0.5 | A | 0.5 | 1 |
| | 29 | 100 | 10 | 30 | 10 | A | 80 | 120 | 8 | A | 0.5 | 1 |
| | 30 | 100 | 10 | 30 | 10 | A | 80 | 120 | 2 | A | 0.008 | 1 |
| | 31 | 100 | 10 | 30 | 10 | A | 80 | 120 | 2 | A | 4.0 | 1 |
| | 32 | 100 | 10 | 30 | 10 | A | 80 | 120 | 2 | A | 0.5 | 0.01 |
| | 33 | 100 | 10 | 30 | 10 | A | 80 | 120 | 2 | A | 0.5 | 2.5 |

| 34 | None | |
|---|---|---|
| 35 | None | |
| 36 | Indicated by (a) as shown in Table 11 | 3 |
| 37 | Indicated by (b) as shown in Table 11 | 3 |
| 38 | Indicated by (c) as shown in Table 11 | 3 |
| 39 | Indicated by (d) as shown in Table 11 | 3 |

(Note 1)
A: Polyurethane
B: Alkyd
C: Acryl
D: Urethane
E: Acrylurethane
(Note 2)
A: SN100D
B: Nano Tek Tinoxide
C: CELAMASE S-8
D: CELNAX CX-Z300H
E: AUP
F: Hitasol GA-66

TABLE 8-1

| | | Press formability | | Seam weldability | | | Spot weldability | | |
|---|---|---|---|---|---|---|---|---|---|
| | | Critical | | | Weld | Weld | | Weld | Weld |
| | | drawing | Powdering | Continuous | crack A | crack B | Continuous | crack C | crack D |
| Category | No. | speed | resistance | weldability | *Note 1 | *Note 2 | weldability | *Note 3 | *Note 4 |
| Exampl | 1 | ∘ | ∘ | ∘ | ∘ | Δ | ∘ | ∘ | Δ |
| | 2 | ∘ | ∘ | ∘ | ∘ | Δ | ∘ | ∘ | Δ |
| | 3 | ∘ | ∘ | ∘ | ∘ | Δ | ∘ | ∘ | Δ |
| | 4 | ∘ | ∘ | ∘ | ∘ | ∘ | ∘ | ∘ | ∘ |
| | 5 | ∘ | ∘ | ∘ | ∘ | ∘ | ∘ | ∘ | ∘ |
| | 6 | ∘ | ∘ | ∘ | ∘ | Δ | ∘ | ∘ | Δ |
| | 7 | ∘ | ∘ | ∘ | ∘ | Δ | ∘ | ∘ | Δ |
| | 8 | ∘ | ∘ | ∘ | ∘ | Δ | ∘ | ∘ | Δ |
| | 9 | ∘ | ∘ | ∘ | ∘ | Δ | ∘ | ∘ | Δ |
| | 10 | ∘ | ∘ | ∘ | ∘ | Δ | ∘ | ∘ | Δ |
| | 11 | ∘ | ∘ | ∘ | ∘ | Δ | ∘ | ∘ | Δ |
| | 12 | ∘ | ∘ | ∘ | ∘ | Δ | ∘ | ∘ | Δ |
| | 13 | ∘ | ∘ | ∘ | ∘ | Δ | ∘ | ∘ | Δ |
| | 14 | ∘ | ∘ | ∘ | ∘ | Δ | ∘ | ∘ | Δ |
| | 15 | ∘ | ∘ | ∘ | ∘ | Δ | ∘ | ∘ | Δ |
| | 16 | ∘ | ∘ | ∘ | ∘ | Δ | ∘ | ∘ | Δ |
| | 17 | ∘ | ∘ | ∘ | ∘ | Δ | ∘ | ∘ | Δ |
| | 18 | ∘ | ∘ | ∘ | ∘ | Δ | ∘ | ∘ | Δ |
| | 19 | ∘ | ∘ | ∘ | ∘ | Δ | ∘ | ∘ | Δ |
| | 20 | ∘ | ∘ | ∘ | ∘ | Δ | ∘ | ∘ | Δ |
| | 21 | ∘ | ∘ | ∘ | ∘ | Δ | ∘ | ∘ | Δ |
| | 22 | ∘ | ∘ | ∘ | ∘ | Δ | ∘ | ∘ | Δ |
| | 23 | ∘ | ∘ | ∘ | ∘ | Δ | ∘ | ∘ | Δ |
| | 24 | ∘ | ∘ | ∘ | ∘ | Δ | ∘ | ∘ | Δ |
| | 25 | ∘ | ∘ | ∘ | ∘ | Δ | ∘ | ∘ | Δ |
| | 26 | ∘ | ∘ | ∘ | ∘ | Δ | ∘ | ∘ | Δ |
| | 27 | ∘ | ∘ | ∘ | ∘ | Δ | ∘ | ∘ | Δ |
| | 28 | ∘ | ∘ | ∘ | ∘ | Δ | ∘ | ∘ | Δ |
| | 29 | ∘ | ∘ | ∘ | ∘ | Δ | ∘ | ∘ | Δ |
| | 30 | ∘ | ∘ | ∘ | ∘ | Δ | ∘ | ∘ | Δ |

| | | | | | Internal corrosion resistance | | | | |
|---|---|---|---|---|---|---|---|---|---|
| | | External corrosion resistance | | | Flat portion | | Worked portion | | |
| | | Flat | Flat cross | Worked | In | In formic | In | In formic | Brazing |
| Category | No. | portion | cut portion | portion | gasoline | acid | gasoline | acid | property |
| Exampl | 1 | ∘ | ∘ | ∘ | ∘ | ∘ | ∘ | ∘ | ∘ |
| | 2 | ∘ | ∘ | ∘ | ∘ | ∘ | ∘ | ∘ | ∘ |
| | 3 | ∘ | ∘ | ∘ | ∘ | ∘ | ∘ | ∘ | ∘ |
| | 4 | ∘ | ∘ | ∘ | ∘ | ∘ | ∘ | ∘ | ∘ |
| | 5 | ∘ | ∘ | ∘ | ∘ | ∘ | ∘ | ∘ | ∘ |
| | 6 | ∘ | ∘ | ∘ | ∘ | ∘ | ∘ | ∘ | ∘ |
| | 7 | ∘ | ∘ | ∘ | ∘ | ∘ | ∘ | ∘ | ∘ |
| | 8 | ∘ | ∘ | ∘ | ∘ | ∘ | ∘ | ∘ | ∘ |
| | 9 | ∘ | ∘ | ∘ | ∘ | ∘ | ∘ | ∘ | ∘ |
| | 10 | ∘ | ∘ | ∘ | ∘ | ∘ | ∘ | ∘ | ∘ |
| | 11 | ∘ | ∘ | ∘ | ∘ | ∘ | ∘ | ∘ | ∘ |
| | 12 | ∘ | Δ | Δ | ∘ | Δ | ∘ | Δ | ∘ |
| | 13 | ∘ | ∘ | ∘ | ∘ | ∘ | ∘ | ∘ | ∘ |
| | 14 | ∘ | ∘ | ∘ | ∘ | ∘ | ∘ | ∘ | ∘ |
| | 15 | ∘ | ∘ | ∘ | ∘ | ∘ | ∘ | ∘ | ∘ |
| | 16 | ∘ | ∘ | ∘ | ∘ | ∘ | ∘ | ∘ | ∘ |
| | 17 | ∘ | ∘ | ∘ | ∘ | ∘ | ∘ | ∘ | ∘ |
| | 18 | ∘ | ∘ | ∘ | ∘ | ∘ | ∘ | ∘ | ∘ |
| | 19 | ∘ | ∘ | ∘ | ∘ | ∘ | ∘ | ∘ | ∘ |
| | 20 | ∘ | ∘ | ∘ | ∘ | ∘ | ∘ | ∘ | ∘ |
| | 21 | ∘ | ∘ | ∘ | ∘ | ∘ | ∘ | ∘ | ∘ |
| | 22 | ∘ | ∘ | ∘ | ∘ | ∘ | ∘ | ∘ | ∘ |
| | 23 | ∘ | ∘ | ∘ | ∘ | ∘ | ∘ | ∘ | ∘ |
| | 24 | ∘ | ∘ | ∘ | ∘ | ∘ | ∘ | ∘ | ∘ |
| | 25 | ∘ | ∘ | ∘ | ∘ | ∘ | ∘ | ∘ | ∘ |
| | 26 | ∘ | ∘ | ∘ | ∘ | ∘ | ∘ | ∘ | ∘ |
| | 27 | ∘ | ∘ | ∘ | ∘ | ∘ | ∘ | ∘ | ∘ |
| | 28 | ∘ | ∘ | ∘ | ∘ | ∘ | ∘ | ∘ | ∘ |
| | 29 | ∘ | ∘ | ∘ | ∘ | ∘ | ∘ | ∘ | ∘ |
| | 30 | ∘ | ∘ | ∘ | ∘ | ∘ | ∘ | ∘ | ∘ |

(Note 1)
Current value; up to the upper limit of the appropriate current range + 3 kA
(Note 2)
Current value: up to the upper limit of the appropriate current range + 7 kA
(Note 3)
Current value: up to the upper limit of the appropriate current range + 3 kA
(Note 4)
Current value: up to the upper limit of the appropriate current range + 7 kA

TABLE 8-2

| | | Press formability | | Seam weldability | | | Spot weldability | | |
|---|---|---|---|---|---|---|---|---|---|
| | | Critical | | | Weld | Weld | | Weld | Weld |
| | | drawing | Powdering | Continuous | crack A | crack B | Continuous | crack C | crack D |
| Category | No. | speed | resistance | weldability | *Note 1 | *Note 2 | weldability | *Note 3 | *Note 4 |
| Exampl | 31 | ∘ | ∘ | ∘ | ∘ | Δ | ∘ | ∘ | Δ |
| | 32 | ∘ | ∘ | ∘ | ∘ | Δ | ∘ | ∘ | Δ |
| | 33 | ∘ | ∘ | ∘ | ∘ | Δ | ∘ | ∘ | Δ |
| | 34 | ∘ | ∘ | ∘ | ∘ | Δ | ∘ | ∘ | Δ |
| | 35 | ∘ | ∘ | ∘ | ∘ | Δ | ∘ | ∘ | Δ |
| | 36 | ∘ | ∘ | ∘ | ∘ | Δ | ∘ | ∘ | Δ |
| | 37 | ∘ | ∘ | ∘ | ∘ | Δ | ∘ | ∘ | Δ |
| | 38 | ∘ | ∘ | ∘ | ∘ | Δ | ∘ | ∘ | Δ |
| | 39 | ∘ | ∘ | ∘ | ∘ | Δ | ∘ | ∘ | Δ |
| | 40 | ∘ | ∘ | ∘ | ∘ | Δ | ∘ | ∘ | Δ |
| | 41 | ∘ | ∘ | ∘ | ∘ | Δ | ∘ | ∘ | Δ |
| | 42 | ∘ | ∘ | ∘ | ∘ | Δ | ∘ | ∘ | Δ |
| | 43 | ∘ | ∘ | ∘ | ∘ | Δ | ∘ | ∘ | Δ |
| | 44 | ∘ | ∘ | ∘ | ∘ | Δ | ∘ | ∘ | Δ |
| | 45 | ∘ | ∘ | ∘ | ∘ | Δ | ∘ | ∘ | Δ |
| | 46 | ∘ | ∘ | ∘ | ∘ | Δ | ∘ | ∘ | Δ |
| | 47 | ∘ | ∘ | ∘ | ∘ | Δ | ∘ | ∘ | Δ |
| | 48 | ∘ | ∘ | ∘ | ∘ | Δ | ∘ | ∘ | Δ |
| | 49 | ∘ | ∘ | ∘ | ∘ | Δ | ∘ | ∘ | Δ |
| | 50 | ∘ | ∘ | ∘ | ∘ | Δ | ∘ | ∘ | Δ |
| | 51 | ∘ | ∘ | ∘ | ∘ | Δ | ∘ | ∘ | Δ |
| | 52 | ∘ | ∘ | ∘ | ∘ | Δ | ∘ | ∘ | Δ |
| | 53 | ∘ | ∘ | ∘ | ∘ | Δ | ∘ | ∘ | Δ |
| | 54 | ∘ | ∘ | ∘ | ∘ | Δ | ∘ | ∘ | Δ |
| | 55 | ∘ | ∘ | ∘ | ∘ | Δ | ∘ | ∘ | Δ |
| | 56 | ∘ | ∘ | ∘ | ∘ | Δ | ∘ | ∘ | Δ |
| | 57 | ∘ | ∘ | ∘ | ∘ | Δ | ∘ | ∘ | Δ |
| | 58 | ∘ | ∘ | ∘ | ∘ | Δ | ∘ | ∘ | Δ |
| | 59 | ∘ | ∘ | ∘ | ∘ | Δ | ∘ | ∘ | Δ |
| | 60 | ∘ | ∘ | ∘ | ∘ | Δ | ∘ | ∘ | Δ |

| | | | | | Internal corrosion resistance | | | | |
|---|---|---|---|---|---|---|---|---|---|
| | | External corrosion resistance | | | Flat portion | | Worked portion | | |
| | | Flat | Flat cross | Worked | In | In formic | In | In formic | Brazing |
| Category | No. | portion | cut portion | portion | gasoline | acid | gasoline | acid | property |
| Exampl | 31 | ∘ | ∘ | ∘ | ∘ | ∘ | ∘ | ∘ | ∘ |
| | 32 | ∘ | ∘ | ∘ | ∘ | ∘ | ∘ | ∘ | ∘ |
| | 33 | ∘ | ∘ | ∘ | ∘ | ∘ | ∘ | ∘ | ∘ |
| | 34 | ∘ | ∘ | ∘ | ∘ | Δ | ∘ | Δ | ∘ |
| | 35 | ∘ | ∘ | ∘ | ∘ | ∘ | ∘ | ∘ | ∘ |
| | 36 | ∘ | ∘ | ∘ | ∘ | ∘ | ∘ | ∘ | ∘ |
| | 37 | ∘ | ∘ | ∘ | ∘ | ∘ | ∘ | ∘ | ∘ |
| | 38 | ∘ | ∘ | ∘ | ∘ | ∘ | ∘ | ∘ | ∘ |
| | 39 | ∘ | ∘ | ∘ | ∘ | ∘ | ∘ | ∘ | ∘ |
| | 40 | ∘ | ∘ | ∘ | ∘ | ∘ | ∘ | ∘ | ∘ |
| | 41 | ∘ | ∘ | ∘ | ∘ | ∘ | ∘ | ∘ | ∘ |
| | 42 | ∘ | ∘ | ∘ | ∘ | ∘ | ∘ | ∘ | ∘ |
| | 43 | ∘ | ∘ | ∘ | ∘ | ∘ | ∘ | ∘ | ∘ |
| | 44 | ∘ | ∘ | ∘ | ∘ | ∘ | ∘ | ∘ | ∘ |
| | 45 | ∘ | ∘ | ∘ | ∘ | ∘ | ∘ | ∘ | ∘ |
| | 46 | ∘ | ∘ | ∘ | ∘ | ∘ | ∘ | ∘ | ∘ |
| | 47 | ∘ | ∘ | ∘ | ∘ | ∘ | ∘ | ∘ | ∘ |
| | 48 | ∘ | ∘ | ∘ | ∘ | ∘ | ∘ | ∘ | ∘ |
| | 49 | ∘ | ∘ | ∘ | ∘ | ∘ | ∘ | ∘ | ∘ |
| | 50 | ∘ | ∘ | ∘ | ∘ | ∘ | ∘ | ∘ | ∘ |
| | 51 | ∘ | ∘ | ∘ | ∘ | ∘ | ∘ | ∘ | ∘ |
| | 52 | ∘ | ∘ | ∘ | ∘ | ∘ | ∘ | ∘ | ∘ |
| | 53 | ∘ | ∘ | ∘ | ∘ | ∘ | ∘ | ∘ | ∘ |
| | 54 | ∘ | ∘ | ∘ | ∘ | ∘ | ∘ | ∘ | ∘ |
| | 55 | ∘ | ∘ | ∘ | ∘ | ∘ | ∘ | ∘ | ∘ |
| | 56 | ∘ | ∘ | ∘ | ∘ | ∘ | ∘ | ∘ | ∘ |
| | 57 | ∘ | ∘ | ∘ | ∘ | ∘ | ∘ | ∘ | ∘ |
| | 58 | ∘ | ∘ | ∘ | ∘ | ∘ | ∘ | ∘ | ∘ |
| | 59 | ∘ | ∘ | ∘ | ∘ | ∘ | ∘ | ∘ | ∘ |
| | 60 | ∘ | Δ | Δ | ∘ | ∘ | ∘ | ∘ | ∘ |

(Note 1)
Current value; up to the upper limit of the appropriate current range + 3 kA
(Note 2)
Current value: up to the upper limit of the appropriate current range + 7 kA
(Note 3)
Current value: up to the upper limit of the appropriate current range + 3 kA
(Note 4)
Current value: up to the upper limit of the appropriate current range + 7 kA

TABLE 8-3

| | | Press formability | | Seam weldability | | | Spot weldability | | |
|---|---|---|---|---|---|---|---|---|---|
| | | Critical | | | Weld | Weld | | Weld | Weld |
| | | drawing | Powdering | Continuous | crack A | crack B | Continuous | crack C | crack D |
| Category | No. | speed | resistance | weldability | *Note 1 | *Note 2 | weldability | *Note 3 | *Note 4 |
| Exampl | 61 | ∘ | ∘ | ∘ | ∘ | Δ | ∘ | ∘ | Δ |
| | 62 | ∘ | ∘ | ∘ | ∘ | Δ | ∘ | ∘ | Δ |
| | 63 | Δ | Δ | ∘ | ∘ | Δ | ∘ | ∘ | Δ |
| | 64 | Δ | Δ | ∘ | ∘ | Δ | ∘ | ∘ | Δ |
| | 65 | Δ | Δ | ∘ | ∘ | Δ | ∘ | ∘ | Δ |
| | 66 | Δ | Δ | ∘ | ∘ | Δ | ∘ | ∘ | Δ |
| | 67 | Δ | Δ | ∘ | ∘ | Δ | ∘ | ∘ | Δ |
| | 68 | Δ | Δ | ∘ | ∘ | Δ | ∘ | ∘ | Δ |
| | 69 | ∘ | ∘ | Δ | ∘ | Δ | Δ | ∘ | Δ |
| | 70 | ∘ | Δ | ∘ | ∘ | Δ | ∘ | ∘ | Δ |
| | 71 | Δ | Δ | ∘ | ∘ | Δ | ∘ | ∘ | Δ |
| | 72 | ∘ | Δ | Δ | ∘ | Δ | Δ | ∘ | Δ |
| | 73 | ∘ | ∘ | ∘ | ∘ | ∘ | ∘ | ∘ | ∘ |
| | 74 | ∘ | ∘ | ∘ | ∘ | ∘ | ∘ | ∘ | ∘ |
| | 75 | ∘ | ∘ | ∘ | ∘ | ∘ | ∘ | ∘ | ∘ |
| | 76 | ∘ | ∘ | ∘ | ∘ | ∘ | ∘ | ∘ | ∘ |
| | 77 | ∘ | ∘ | ∘ | ∘ | ∘ | ∘ | ∘ | ∘ |
| | 78 | ∘ | ∘ | ∘ | ∘ | ∘ | ∘ | ∘ | ∘ |
| | 79 | ∘ | ∘ | ∘ | ∘ | ∘ | ∘ | ∘ | ∘ |
| | 80 | ∘ | ∘ | ∘ | ∘ | ∘ | ∘ | ∘ | ∘ |
| | 81 | ∘ | ∘ | ∘ | ∘ | ∘ | ∘ | ∘ | ∘ |
| | 82 | ∘ | ∘ | ∘ | ∘ | ∘ | ∘ | ∘ | ∘ |
| | 83 | ∘ | ∘ | ∘ | ∘ | ∘ | ∘ | ∘ | ∘ |
| | 84 | ∘ | ∘ | ∘ | ∘ | ∘ | ∘ | ∘ | ∘ |
| | 85 | ∘ | ∘ | ∘ | ∘ | ∘ | ∘ | ∘ | ∘ |
| | 86 | ∘ | ∘ | ∘ | ∘ | ∘ | ∘ | ∘ | ∘ |
| | 87 | ∘ | ∘ | ∘ | ∘ | ∘ | ∘ | ∘ | ∘ |
| | 88 | ∘ | ∘ | ∘ | ∘ | ∘ | ∘ | ∘ | ∘ |
| | 89 | ∘ | ∘ | ∘ | ∘ | ∘ | ∘ | ∘ | ∘ |
| | 90 | ∘ | ∘ | ∘ | ∘ | ∘ | ∘ | ∘ | ∘ |

| | | | | | Internal corrosion resistance | | | | |
|---|---|---|---|---|---|---|---|---|---|
| | | External corrosion resistance | | | Flat portion | | Worked portion | | |
| | | Flat | Flat cross | Worked | In | In formic | In | In formic | Brazing |
| Category | No. | portion | cut portion | portion | gasoline | acid | gasoline | acid | property |
| Exampl | 61 | ∘ | ∘ | ∘ | ∘ | ∘ | ∘ | ∘ | ∘ |
| | 62 | ∘ | ∘ | ∘ | ∘ | ∘ | ∘ | ∘ | Δ |
| | 63 | Δ | Δ | Δ | ∘ | ∘ | ∘ | ∘ | ∘ |
| | 64 | ∘ | ∘ | Δ | ∘ | ∘ | ∘ | ∘ | ∘ |
| | 65 | ∘ | ∘ | Δ | ∘ | ∘ | ∘ | ∘ | ∘ |
| | 66 | ∘ | ∘ | Δ | ∘ | ∘ | ∘ | ∘ | ∘ |
| | 67 | ∘ | ∘ | Δ | ∘ | ∘ | ∘ | ∘ | ∘ |
| | 68 | Δ | Δ | Δ | ∘ | ∘ | ∘ | ∘ | ∘ |
| | 69 | ∘ | ∘ | ∘ | ∘ | ∘ | ∘ | ∘ | ∘ |
| | 70 | ∘ | ∘ | Δ | ∘ | ∘ | ∘ | ∘ | ∘ |
| | 71 | Δ | Δ | Δ | ∘ | ∘ | ∘ | ∘ | ∘ |
| | 72 | ∘ | ∘ | Δ | ∘ | ∘ | ∘ | ∘ | Δ |
| | 73 | ∘ | ∘ | ∘ | ∘ | ∘ | ∘ | ∘ | ∘ |
| | 74 | ∘ | ∘ | ∘ | ∘ | ∘ | ∘ | ∘ | ∘ |
| | 75 | ∘ | ∘ | ∘ | ∘ | ∘ | ∘ | ∘ | ∘ |
| | 76 | ∘ | ∘ | ∘ | ∘ | ∘ | ∘ | ∘ | ∘ |
| | 77 | ∘ | ∘ | ∘ | ∘ | ∘ | ∘ | ∘ | ∘ |
| | 78 | ∘ | ∘ | ∘ | ∘ | ∘ | ∘ | ∘ | ∘ |
| | 79 | ∘ | ∘ | ∘ | ∘ | ∘ | ∘ | ∘ | ∘ |
| | 80 | ∘ | ∘ | ∘ | ∘ | ∘ | ∘ | ∘ | ∘ |
| | 81 | ∘ | ∘ | ∘ | ∘ | ∘ | ∘ | ∘ | ∘ |
| | 82 | ∘ | ∘ | ∘ | ∘ | ∘ | ∘ | ∘ | ∘ |
| | 83 | ∘ | ∘ | ∘ | ∘ | ∘ | ∘ | ∘ | ∘ |
| | 84 | ∘ | Δ | Δ | ∘ | Δ | ∘ | Δ | ∘ |
| | 85 | ∘ | ∘ | ∘ | ∘ | ∘ | ∘ | ∘ | ∘ |
| | 86 | ∘ | ∘ | ∘ | ∘ | ∘ | ∘ | ∘ | ∘ |
| | 87 | ∘ | ∘ | ∘ | ∘ | ∘ | ∘ | ∘ | ∘ |
| | 88 | ∘ | ∘ | ∘ | ∘ | ∘ | ∘ | ∘ | ∘ |
| | 89 | ∘ | ∘ | ∘ | ∘ | ∘ | ∘ | ∘ | ∘ |
| | 90 | ∘ | ∘ | ∘ | ∘ | ∘ | ∘ | ∘ | ∘ |

(Note 1)
Current value; up to the upper limit of the appropriate current range + 3 kA
(Note 2)
Current value: up to the upper limit of the appropriate current range + 7 kA
(Note 3)
Current value: up to the upper limit of the appropriate current range + 3 kA
(Note 4)
Current value: up to the upper limit of the appropriate current range + 7 kA

TABLE 9-1

| | | Press formability | | Seam weldability | | | Spot weldability | | |
|---|---|---|---|---|---|---|---|---|---|
| | | Critical | | | Weld | Weld | | Weld | Weld |
| | | drawing | Powdering | Continuous | crack A | crack B | Continuous | crack C | crack D |
| Category | No. | speed | resistance | weldability | *Note 1 | *Note 2 | weldability | *Note 3 | *Note 4 |
| Exampl | 91 | ∘ | ∘ | ∘ | ∘ | ∘ | ∘ | ∘ | ∘ |
| | 92 | ∘ | ∘ | ∘ | ∘ | ∘ | ∘ | ∘ | ∘ |
| | 93 | ∘ | ∘ | ∘ | ∘ | ∘ | ∘ | ∘ | ∘ |
| | 94 | ∘ | ∘ | ∘ | ∘ | ∘ | ∘ | ∘ | ∘ |
| | 95 | ∘ | ∘ | ∘ | ∘ | ∘ | ∘ | ∘ | ∘ |
| | 96 | ∘ | ∘ | ∘ | ∘ | ∘ | ∘ | ∘ | ∘ |
| | 97 | ∘ | ∘ | ∘ | ∘ | ∘ | ∘ | ∘ | ∘ |
| | 98 | ∘ | ∘ | ∘ | ∘ | ∘ | ∘ | ∘ | ∘ |
| | 99 | ∘ | ∘ | ∘ | ∘ | ∘ | ∘ | ∘ | ∘ |
| | 100 | ∘ | ∘ | ∘ | ∘ | ∘ | ∘ | ∘ | ∘ |
| | 101 | ∘ | ∘ | ∘ | ∘ | ∘ | ∘ | ∘ | ∘ |
| | 102 | ∘ | ∘ | ∘ | ∘ | ∘ | ∘ | ∘ | ∘ |
| | 103 | ∘ | ∘ | ∘ | ∘ | ∘ | ∘ | ∘ | ∘ |
| | 104 | ∘ | ∘ | ∘ | ∘ | ∘ | ∘ | ∘ | ∘ |
| | 105 | ∘ | ∘ | ∘ | ∘ | ∘ | ∘ | ∘ | ∘ |
| | 106 | ∘ | ∘ | ∘ | ∘ | ∘ | ∘ | ∘ | ∘ |
| | 107 | ∘ | ∘ | ∘ | ∘ | ∘ | ∘ | ∘ | ∘ |
| | 108 | ∘ | ∘ | ∘ | ∘ | ∘ | ∘ | ∘ | ∘ |
| | 109 | ∘ | ∘ | ∘ | ∘ | ∘ | ∘ | ∘ | ∘ |
| | 110 | ∘ | ∘ | ∘ | ∘ | ∘ | ∘ | ∘ | ∘ |
| | 111 | ∘ | ∘ | ∘ | ∘ | ∘ | ∘ | ∘ | ∘ |
| | 112 | ∘ | ∘ | ∘ | ∘ | ∘ | ∘ | ∘ | ∘ |
| | 113 | ∘ | ∘ | ∘ | ∘ | ∘ | ∘ | ∘ | ∘ |
| | 114 | ∘ | ∘ | ∘ | ∘ | ∘ | ∘ | ∘ | ∘ |
| | 115 | ∘ | ∘ | ∘ | ∘ | ∘ | ∘ | ∘ | ∘ |
| | 116 | ∘ | ∘ | ∘ | ∘ | ∘ | ∘ | ∘ | ∘ |
| | 117 | ∘ | ∘ | ∘ | ∘ | ∘ | ∘ | ∘ | ∘ |
| | 118 | ∘ | ∘ | ∘ | ∘ | ∘ | ∘ | ∘ | ∘ |

| | | | | | Internal corrosion resistance | | | | |
|---|---|---|---|---|---|---|---|---|---|
| | | External corrosion resistance | | | Flat portion | | Worked portion | | |
| | | Flat | Flat cross | Worked | In | In formic | In | In formic | Brazing |
| Category | No. | portion | cut portion | portion | gasoline | acid | gasoline | acid | property |
| Exampl | 91 | ∘ | ∘ | ∘ | ∘ | ∘ | ∘ | ∘ | ∘ |
| | 92 | ∘ | ∘ | ∘ | ∘ | ∘ | ∘ | ∘ | ∘ |
| | 93 | ∘ | ∘ | ∘ | ∘ | ∘ | ∘ | ∘ | ∘ |
| | 94 | ∘ | ∘ | ∘ | ∘ | ∘ | ∘ | ∘ | ∘ |
| | 95 | ∘ | ∘ | ∘ | ∘ | ∘ | ∘ | ∘ | ∘ |
| | 96 | ∘ | ∘ | ∘ | ∘ | ∘ | ∘ | ∘ | ∘ |
| | 97 | ∘ | ∘ | ∘ | ∘ | ∘ | ∘ | ∘ | ∘ |
| | 98 | ∘ | ∘ | ∘ | ∘ | ∘ | ∘ | ∘ | ∘ |
| | 99 | ∘ | ∘ | ∘ | ∘ | ∘ | ∘ | ∘ | ∘ |
| | 100 | ∘ | ∘ | ∘ | ∘ | ∘ | ∘ | ∘ | ∘ |
| | 101 | ∘ | ∘ | ∘ | ∘ | ∘ | ∘ | ∘ | ∘ |
| | 102 | ∘ | ∘ | ∘ | ∘ | ∘ | ∘ | ∘ | ∘ |
| | 103 | ∘ | ∘ | ∘ | ∘ | ∘ | ∘ | ∘ | ∘ |
| | 104 | ∘ | ∘ | ∘ | ∘ | ∘ | ∘ | ∘ | ∘ |
| | 105 | ∘ | ∘ | ∘ | ∘ | ∘ | ∘ | ∘ | ∘ |
| | 106 | ∘ | ∘ | ∘ | ∘ | Δ | ∘ | Δ | ∘ |
| | 107 | ∘ | ∘ | ∘ | ∘ | ∘ | ∘ | ∘ | ∘ |
| | 108 | ∘ | ∘ | ∘ | ∘ | ∘ | ∘ | ∘ | ∘ |
| | 109 | ∘ | ∘ | ∘ | ∘ | ∘ | ∘ | ∘ | ∘ |
| | 110 | ∘ | ∘ | ∘ | ∘ | ∘ | ∘ | ∘ | ∘ |
| | 111 | ∘ | ∘ | ∘ | ∘ | ∘ | ∘ | ∘ | ∘ |
| | 112 | ∘ | ∘ | ∘ | ∘ | ∘ | ∘ | ∘ | ∘ |
| | 113 | ∘ | ∘ | ∘ | ∘ | ∘ | ∘ | ∘ | ∘ |
| | 114 | ∘ | ∘ | ∘ | ∘ | ∘ | ∘ | ∘ | ∘ |
| | 115 | ∘ | ∘ | ∘ | ∘ | ∘ | ∘ | ∘ | ∘ |
| | 116 | ∘ | ∘ | ∘ | ∘ | ∘ | ∘ | ∘ | ∘ |
| | 117 | ∘ | ∘ | ∘ | ∘ | ∘ | ∘ | ∘ | ∘ |
| | 118 | ∘ | ∘ | ∘ | ∘ | ∘ | ∘ | ∘ | ∘ |

(Note 1)
Current value; up to the upper limit of the appropriate current range + 3 kA
(Note 2)
Current value: up to the upper limit of the appropriate current range + 7 kA
(Note 3)
Current value: up to the upper limit of the appropriate current range + 3 kA
(Note 4)
Current value: up to the upper limit of the appropriate current range + 7 kA

TABLE 9-2

| | | Press formability | | Seam weldability | | | Spot weldability | | |
|---|---|---|---|---|---|---|---|---|---|
| | | Critical | | | Weld | Weld | | Weld | Weld |
| | | drawing | Powdering | Continuous | crack A | crack B | Continuous | crack C | crack D |
| Category | No. | speed | resistance | weldability | *Note 1 | *Note 2 | weldability | *Note 3 | *Note 4 |
| Example | 119 | ∘ | ∘ | ∘ | ∘ | ∘ | ∘ | ∘ | ∘ |
| | 120 | ∘ | ∘ | ∘ | ∘ | ∘ | ∘ | ∘ | ∘ |
| | 121 | ∘ | ∘ | ∘ | ∘ | ∘ | ∘ | ∘ | ∘ |
| | 122 | ∘ | ∘ | ∘ | ∘ | ∘ | ∘ | ∘ | ∘ |
| | 123 | ∘ | ∘ | ∘ | ∘ | ∘ | ∘ | ∘ | ∘ |
| | 124 | ∘ | ∘ | ∘ | ∘ | ∘ | ∘ | ∘ | ∘ |
| | 125 | ∘ | ∘ | ∘ | ∘ | ∘ | ∘ | ∘ | ∘ |
| | 126 | ∘ | ∘ | ∘ | ∘ | ∘ | ∘ | ∘ | ∘ |
| | 127 | ∘ | ∘ | ∘ | ∘ | ∘ | ∘ | ∘ | ∘ |
| | 128 | ∘ | ∘ | ∘ | ∘ | ∘ | ∘ | ∘ | ∘ |
| | 129 | ∘ | ∘ | ∘ | ∘ | ∘ | ∘ | ∘ | ∘ |
| | 130 | ∘ | ∘ | ∘ | ∘ | ∘ | ∘ | ∘ | ∘ |
| | 131 | ∘ | ∘ | ∘ | ∘ | ∘ | ∘ | ∘ | ∘ |
| | 132 | ∘ | ∘ | ∘ | ∘ | ∘ | ∘ | ∘ | ∘ |
| | 133 | ∘ | ∘ | ∘ | ∘ | ∘ | ∘ | ∘ | ∘ |
| | 134 | ∘ | ∘ | ∘ | ∘ | ∘ | ∘ | ∘ | ∘ |
| | 135 | ∘ | ∘ | ∘ | ∘ | Δ | ∘ | ∘ | Δ |
| | 136 | Δ | Δ | ∘ | ∘ | ∘ | ∘ | ∘ | ∘ |
| Comparati | 1 | ∘ | ∘ | Δ | x | x | Δ | x | x |
| Example | 2 | x | x | ∘ | ∘ | ∘ | ∘ | ∘ | ∘ |
| | 3 | x | x | x | ∘ | ∘ | x | ∘ | ∘ |
| | 4 | ∘ | ∘ | x | ∘ | ∘ | x | ∘ | ∘ |
| | 5 | x | x | ∘ | ∘ | ∘ | ∘ | ∘ | ∘ |
| | 6 | Δ | Δ | ∘ | ∘ | ∘ | ∘ | ∘ | ∘ |
| | 7 | x | x | ∘ | ∘ | ∘ | ∘ | ∘ | ∘ |
| | 8 | ∘ | ∘ | x | ∘ | ∘ | x | ∘ | ∘ |
| | 9 | ∘ | — | x | ∘ | ∘ | x | ∘ | ∘ |
| | 10 | Δ | — | x | ∘ | ∘ | x | ∘ | ∘ |

| | | | | | Internal corrosion resistance | | | | |
|---|---|---|---|---|---|---|---|---|---|
| | | External corrosion resistance | | | Flat portion | | Worked portion | | |
| | | Flat | Flat cross | Worked | In | In formic | In | In formic | Brazing |
| Category | No. | portion | cut portion | portion | gasoline | acid | gasoline | acid | property |
| Example | 119 | ∘ | ∘ | ∘ | ∘ | ∘ | ∘ | ∘ | ∘ |
| | 120 | ∘ | ∘ | ∘ | ∘ | ∘ | ∘ | ∘ | ∘ |
| | 121 | ∘ | ∘ | ∘ | ∘ | ∘ | ∘ | ∘ | ∘ |
| | 122 | ∘ | ∘ | ∘ | ∘ | ∘ | ∘ | ∘ | ∘ |
| | 123 | ∘ | ∘ | ∘ | ∘ | ∘ | ∘ | ∘ | ∘ |
| | 124 | ∘ | ∘ | ∘ | ∘ | ∘ | ∘ | ∘ | ∘ |
| | 125 | ∘ | ∘ | ∘ | ∘ | ∘ | ∘ | ∘ | ∘ |
| | 126 | ∘ | ∘ | ∘ | ∘ | ∘ | ∘ | ∘ | ∘ |
| | 127 | ∘ | ∘ | ∘ | ∘ | ∘ | ∘ | ∘ | ∘ |
| | 128 | ∘ | ∘ | ∘ | ∘ | ∘ | ∘ | ∘ | ∘ |
| | 129 | ∘ | ∘ | ∘ | ∘ | ∘ | ∘ | ∘ | ∘ |
| | 130 | ∘ | ∘ | ∘ | ∘ | ∘ | ∘ | ∘ | ∘ |
| | 131 | ∘ | ∘ | ∘ | ∘ | ∘ | ∘ | ∘ | ∘ |
| | 132 | ∘ | Δ | Δ | ∘ | ∘ | ∘ | ∘ | ∘ |
| | 133 | ∘ | ∘ | ∘ | ∘ | ∘ | ∘ | ∘ | ∘ |
| | 134 | ∘ | ∘ | ∘ | ∘ | ∘ | ∘ | ∘ | ∘ |
| | 135 | ∘ | ∘ | ∘ | ∘ | ∘ | ∘ | ∘ | ∘ |
| | 136 | ∘ | ∘ | Δ | ∘ | ∘ | Δ | Δ | ∘ |
| Comparati | 1 | ∘ | ∘ | ∘ | ∘ | ∘ | ∘ | ∘ | ∘ |
| Example | 2 | ∘ | ∘ | x | ∘ | ∘ | Δ | x | ∘ |
| | 3 | x | x | x | x | x | x | x | ∘ |
| | 4 | ∘ | ∘ | ∘ | x | x | x | x | ∘ |
| | 5 | ∘ | ∘ | ∘ | Δ | Δ | x | x | ∘ |
| | 6 | x | x | x | ∘ | ∘ | ∘ | ∘ | ∘ |
| | 7 | x | x | x | ∘ | ∘ | ∘ | ∘ | x |
| | 8 | ∘ | ∘ | ∘ | ∘ | ∘ | ∘ | ∘ | ∘ |
| | 9 | ∘ | Δ | x | Δ | x | Δ | x | ∘ |
| | 10 | Δ | x | x | Δ | x | Δ | x | ∘ |

(Note 1)
Current value; up to the upper limit of the appropriate current range + 3 kA
(Note 2)
Current value: up to the upper limit of the appropriate current range + 7 kA
(Note 3)
Current value: up to the upper limit of the appropriate current range + 3 kA
(Note 4)
Current value: up to the upper limit of the appropriate current range + 7 kA

TABLE 9-3

| | | Press formability | | Seam weldability | | | Spot weldability | | |
|---|---|---|---|---|---|---|---|---|---|
| | | Critical | | | Weld | Weld | | Weld | Weld |
| | | drawing | Powdering | Continuous | crack A | crack B | Continuous | crack C | crack D |
| Category | No. | speed | resistance | weldability | *Note 1 | *Note 2 | weldability | *Note 3 | *Note 4 |
| Comparati | 11 | x | x | x | ∘ | ∘ | x | ∘ | ∘ |
| Example | 12 | x | x | x | ∘ | ∘ | x | ∘ | ∘ |
| | 13 | x | x | x | ∘ | ∘ | x | ∘ | ∘ |
| | 14 | x | x | x | ∘ | ∘ | x | ∘ | ∘ |
| | 15 | ∘ | ∘ | ∘ | Δ | x | ∘ | Δ | x |
| | 16 | x | Δ | ∘ | ∘ | ∘ | ∘ | ∘ | ∘ |
| | 17 | x | x | ∘ | x | x | ∘ | x | x |
| | 18 | x | x | x | ∘ | ∘ | x | ∘ | ∘ |
| | 19 | ∘ | ∘ | x | ∘ | ∘ | x | ∘ | ∘ |
| | 20 | x | x | ∘ | ∘ | ∘ | ∘ | ∘ | ∘ |
| | 21 | Δ | Δ | ∘ | ∘ | ∘ | ∘ | ∘ | ∘ |
| | 22 | x | x | ∘ | ∘ | ∘ | ∘ | ∘ | ∘ |
| | 23 | ∘ | ∘ | x | ∘ | ∘ | x | ∘ | ∘ |
| | 24 | x | x | ∘ | ∘ | ∘ | ∘ | ∘ | ∘ |
| | 25 | x | x | Δ | ∘ | ∘ | Δ | ∘ | ∘ |
| | 26 | x | x | ∘ | ∘ | ∘ | ∘ | ∘ | ∘ |
| | 27 | x | x | ∘ | ∘ | ∘ | ∘ | ∘ | ∘ |
| | 28 | x | x | ∘ | ∘ | ∘ | ∘ | ∘ | ∘ |
| | 29 | x | x | ∘ | ∘ | ∘ | ∘ | ∘ | ∘ |
| | 30 | ∘ | ∘ | x | ∘ | ∘ | x | ∘ | ∘ |
| | 31 | Δ | Δ | x | ∘ | ∘ | x | ∘ | ∘ |
| | 32 | x | x | ∘ | ∘ | ∘ | ∘ | ∘ | ∘ |
| | 33 | ∘ | Δ | x | ∘ | ∘ | x | ∘ | ∘ |
| | 34 | ∘ | — | x | ∘ | ∘ | x | ∘ | ∘ |
| | 35 | Δ | — | x | ∘ | ∘ | x | ∘ | ∘ |
| | 36 | x | x | x | ∘ | ∘ | x | ∘ | ∘ |
| | 37 | x | x | x | ∘ | ∘ | x | ∘ | ∘ |
| | 38 | x | x | x | ∘ | ∘ | x | ∘ | ∘ |
| | 39 | x | x | x | ∘ | ∘ | x | ∘ | ∘ |

| | | | | | Internal corrosion resistance | | | | |
|---|---|---|---|---|---|---|---|---|---|
| | | External corrosion resistance | | | Flat portion | | Worked portion | | |
| | | Flat | Flat cross | Worked | In | In formic | In | In formic | Brazing |
| Category | No. | portion | cut portion | portion | gasoline | acid | gasoline | acid | property |
| Comparati | 11 | ∘ | ∘ | x | x | x | x | x | x |
| Example | 12 | ∘ | ∘ | x | x | x | x | x | x |
| | 13 | ∘ | ∘ | x | x | x | x | x | x |
| | 14 | ∘ | ∘ | x | x | x | x | x | x |
| | 15 | ∘ | ∘ | ∘ | ∘ | ∘ | ∘ | ∘ | ∘ |
| | 16 | ∘ | ∘ | x | ∘ | ∘ | Δ | x | ∘ |
| | 17 | ∘ | ∘ | x | ∘ | ∘ | x | x | ∘ |
| | 18 | x | x | x | x | x | x | x | ∘ |
| | 19 | ∘ | ∘ | ∘ | x | x | x | x | ∘ |
| | 20 | ∘ | ∘ | ∘ | Δ | Δ | x | x | ∘ |
| | 21 | x | x | x | ∘ | ∘ | ∘ | ∘ | ∘ |
| | 22 | x | x | x | ∘ | ∘ | ∘ | ∘ | ∘ |
| | 23 | ∘ | ∘ | ∘ | ∘ | ∘ | ∘ | ∘ | ∘ |
| | 24 | x | x | x | ∘ | ∘ | ∘ | ∘ | ∘ |
| | 25 | x | x | x | ∘ | ∘ | ∘ | ∘ | ∘ |
| | 26 | ∘ | ∘ | x | ∘ | ∘ | ∘ | ∘ | ∘ |
| | 27 | ∘ | ∘ | x | ∘ | ∘ | ∘ | ∘ | ∘ |
| | 28 | ∘ | ∘ | x | ∘ | ∘ | ∘ | ∘ | ∘ |
| | 29 | x | x | x | ∘ | ∘ | ∘ | ∘ | ∘ |
| | 30 | ∘ | ∘ | ∘ | ∘ | ∘ | ∘ | ∘ | ∘ |
| | 31 | ∘ | ∘ | Δ | ∘ | ∘ | ∘ | ∘ | ∘ |
| | 32 | x | x | x | ∘ | ∘ | ∘ | ∘ | ∘ |
| | 33 | ∘ | ∘ | x | ∘ | ∘ | ∘ | x | x |
| | 34 | ∘ | Δ | x | Δ | x | Δ | ∘ | ∘ |
| | 35 | Δ | x | x | Δ | x | Δ | ∘ | ∘ |
| | 36 | ∘ | ∘ | x | x | x | x | x | x |
| | 37 | ∘ | ∘ | x | x | x | x | x | x |
| | 38 | ∘ | ∘ | x | x | x | x | x | x |
| | 39 | ∘ | ∘ | x | x | x | x | x | x |

(Note 1)
Current value; up to the upper limit of the appropriate current range + 3 kA
(Note 2)
Current value: up to the upper limit of the appropriate current range + 7 kA
(Note 3)
Current value: up to the upper limit of the appropriate current range + 3 kA
(Note 4)
Current value: up to the upper limit of the appropriate current range + 7 kA

TABLE 10
Welding condition

| | |
|---|---|
| Electrode force (kN) | 1.96 |
| Welding current (kA) | 5 |
| Squeeze time (cycle) | 60 |
| Up slope time (cycle) | 2 |
| Weld time / first stage (cycle) | 5 |
| Cool time (cycle) | 2 |
| Weld time / second stage (cycle) | 12 |
| Welding current (kA) | 5 |
| Hold time (cycle) | 10 |

TABLE 11

| | (a) | (b) | (c) | (d) |
|---|---|---|---|---|
| | Weight | Weight | Weight | Weight |
| | (g) | (g) | (g) | (g) |
| Phenoxy resin | 112.00 | 112.00 | 112.00 | 112.00 |
| (manufactured by Ciba-Geigy, | | | | |
| GZ9713) | | | | |
| Calcium oxide | 1.09 | 1.09 | 1.09 | 1.09 |
| (manufactured by Baker Products) | | | | |
| Hygroscopic agent | 1.09 | 1.09 | 1.09 | 1.09 |
| (manufactured by Davidson Chem, | | | | |
| Syliod AL-1) | | | | |
| Phenolic resin | 4.04 | 4.04 | 4.04 | 4.04 |
| (manufactured by Ciba-Geigy, | | | | |
| HZ949U) | | | | |
| Curing agent | 5.67 | 5.67 | 5.67 | 5.67 |
| (manufactured by Reichhold | | | | |
| Chem, MX-61) | | | | |
| Aluminum powder | 13.61 | 11.60 | 20.40 | 27.20 |
| (manufactured by Alcoa, 5250) | | | | |
| Polytetrafluoroethylene | 1.41 | 1.41 | 1.41 | 1.41 |
| (manufactured by Micro Powders, | | | | |
| HT-1) | | | | |
| Nickel powder | 22.68 | 22.68 | 22.68 | 22.68 |
| (manufactured by Inco, 525) | | | | |
| Suspension agent | 5.99 | 5.99 | 5.99 | 5.99 |
| (manufactured by Poly Resyn, | | | | |
| Suspensol 220) | | | | |

### INDUSTRIAL APPLICABILITY

According to the steel sheet for a gasoline tank of the present invention, it has become possible to provide a highly corrosion-resistant steel sheet for a fuel tank especially having further improved resistance weldability compared to that of the steel sheet for a fuel tank, as disclosed in Japanese Unexamined Patent Application Publication No. 10-337805, having superior resistance weldability and press formability, and in addition to this, having superior corrosion resistance, in particular, the corrosion resistance to alcohol or gasoline blended with alcohol and formic acid. Furthermore, since it contains no lead, which is a hazardous material, it has extremely high industrial value as a steel sheet for a fuel tank.

What is claimed is:

1. A highly corrosion-resistant steel sheet for a fuel tank, wherein a zinc-based plating layer and a chromate layer are formed in order by lamination on both surfaces of a steel sheet comprising C; 0.0007 to 0.0050 mass %, Si: 0.5 mass % or less, Mn: 2.0 mass % or less, P: 0.10 mass % or less, S: 0.015 mass % or less, Al: 0.01 to 0.20 mass %, N: 0.01 mass % or less, Ti: 0.005 to 0.08 mass %, and B: 0.001 to 0.01 mass %, a first composite coating comprising metal powders of Al and Ni and an amine-modified epoxy resin is formed on the chromate layer formed on one surface side of the steel sheet, and a second composite coating comprising silica, a lubricant, a particle having conductivity, and at least one kind of organic resin having at least one functional group selected from the group consisting of a hydroxyl group, an isocyanate group, a carboxyl group, a glycidyl group, and an amino group is formed on the chromate layer formed on the other surface side.

2. The highly corrosion-resistant steel sheet for a fuel tank according to claim 1, wherein the P content in the steel sheet is 0.01 to 0.05 mass %.

3. The highly corrosion-resistant steel sheet for a fuel tank according to claim 1 or 2, wherein the particle having conductivity in the second composite coating is at least one kind selected from the group consisting of a metal particle, a metal compound particle, and a graphite particle.
